(19) United States
(12) Patent Application Publication
(10) Pub. No.: US 2008/0258550 A1
(43) Pub. Date: Oct. 23, 2008

(54) Hybrid Combination of Rubber Track with Road Wheels for a Vehicle

(75) Inventors: TIMOTHY WEBSTER, VANCOUVER (CA); ASHU M.G. SOLO, SASKATOON (CA); QING WU, BURNABY (CA); WEN JUN YANG, BURNABY (CA)

Correspondence Address: TIMOTHY WEBSTER, Suite 1101, 789 Drake Street, Vancouver, BC, V6Z 2N7, CA

(73) Assignee: Mr. TIMOTHY DAVID WEBSTER, VANCOUVER (CA)

(21) Appl. No.: 12/107,752

(22) Filed: Apr. 22, 2008

Related U.S. Application Data
(60) Provisional application No. 60/913,356, filed on Apr. 23, 2007.

(51) Int. Cl. B62D 55/14

(52) U.S. Cl. 305/129

(57) ABSTRACT

Described is a belt used in conjunction with road wheels device and method of supporting weight of hybrid tire tracking-laying vehicles more safely and efficiently at highway speeds. The supporting device includes belts 004, road tires 002, track tires 003, tensioning tires 015, and supporting frame and axles. The road tires 002 are located outside beside the belt 004 with a larger diameter than the belt 004. The outside road tires work to laterally guide the belt 004 and to prevent the rubber belt 004 from track-throwing. The tensioning tires 015 running inside the belt 004 along the wheel runways 027, are guided by the belt guide horns 020. In this proposed device, the belt 004 can remain sufficiently taut to prevent the guide horns 020 from slipping over the track tires 003 and road tires 002. The designed hybrid belt with tires can remove debris such as mud and sand, and prevent track-throwing even during turning maneuvers.

### BACKGROUND

1. Field of Invention

This invention relates to a hybrid combination of tracks in conjunction with road wheels for vehicles.

2. Description of Prior Art

Numerous types of vehicles are frequently used in terrain in which it is difficult for pneumatic tires to operate. Amphibious vehicles, military tanks, construction equipment, tractors, and recreational vehicles may be required to operate on terrains that are very soft and/or debris covered, such as sand, mud, rocks, tree branches, and building debris. Pneumatic tires are not very capable of efficient operation on the above mentioned soft and/or debris covered surfaces, as they tend to burrow into the surface rather than riding across the surface and climbing over debris.

Belt vehicles have been developed for use on terrains in which pneumatic tire vehicles are impractical. For example, see U.S. Pat. Nos. 3,361,488 (Ohm et al), 3,688,858 (Jesperson), 3,734,577 (Snellman), and 3,955,855 (Massieon et al). In many types of terrain, these vehicles provide improved performance relative to the performance of a pneumatic tire vehicle. Still difficulties are encountered with existing belt vehicles.

Originally, such tracks were made of a plurality of metal links or shoes pivotally attached to each other to form an belt, which is very heavy and causes serious damage to surfaces on which it runs. Metal links are also noisy, an uncomfortable ride for passengers, and require significantly more maintenance when operated at high speeds. For example, see U.S. Pat. Nos. 2,823,082 (Bauer) and 4,530,546 (Meisel, Jr.). Heavy off-road only vehicles and construction equipment that travel at low speeds may still use metal tracks.

A need has developed for a low maintenance form of vehicle appropriate for both normal road use and off-road use. There is a significant need for a vehicle capable of rapid responses to armed conflicts and natural emergencies. Also, a load carrying vehicle that is both on road and off road would be useful in many areas, such as construction, agriculture, and undeveloped regions without extensive road infrastructure. Most load carrying off-road vehicles presently have very large wheels or very cumbersome tracks, which are heavy, slow moving, prone to coming off in debris, inappropriate for use on roads at normal highway speeds, and which wear excessively when used on hard surfaces.

Rubber belts have become popular for construction and low soil compaction farming equipment that must travel or operate on road surfaces. With the combination of rubber technology and a tremendous amount of trial and error, various types of rubber tracks are now available. For example, see U.S. Pat. Nos. 5,279,378 (Graiwey et al) and 6,267,458 (Hansen et al). Most equipment is operated on the job site only and is transported between sites by trucks or trailers. To eliminate the inconvenience of transporting the vehicle between job sites, a vehicle that can operate on both public roads at normal speeds and off road is required.

A number of hybrid steel tracks with rubber pads have been proposed where the links or shoes are made of metal that is provided with a rubber cover or insert. For example, see U.S. Pat. Nos. 2,359,586 (Sayler), 2,369,130 (Benson), 2,409,502 (Leguillon et al), 3,148,921 (Batur et al), 4,109,971 (Black et al), 4,359,248 (Kortering), and 4,588,233 (DenBensten). While these hybrid tracks reduce noise and greatly reduce road damage, they are still relatively slow moving, prone to coming off in debris, worn excessively when used on hard surfaces, and inappropriate for use on roads at normal highway speeds. Hybrid steel tracks with rubber pads are more complex than rubber tracks and require more maintenance. However, they are capable of carrying extreme loads.

Rubber tracks are generally capable of higher speeds than either steel or hybrid tracks. However, no track vehicle can match the high speed at which pneumatic tire vehicles can comfortably operate. All tracked vehicles are prone to coming off in debris and wear excessively when used on hard surfaces.

Some of the problems encountered in using such an endless rubber track in practice are maintaining adequate uniform tension on the rubber track as it twists to accommodate even a small amount of misalignment, keeping the rubber track lateral and aligned with each track wheel when there is even a small amount of misalignment, keeping the rubber track in lateral alignment with the track wheels when it is subjected to large lateral loads occurring during turning maneuvers or on steep inclines, as well as debris wedging between the rubber track and the track wheels affecting alignment and the ability to drive the rubber track.

Throwing a track is the most dangerous and catastrophic problem that can occur during the operation of rubber tracks. As travel velocity increases the energy, the resulting danger posed by throwing a track increases with the velocity squared. At road traffic speeds, sudden maneuvers, such as sudden lane changes could result in throwing a track. An unbalanced track or slack in the rubber track and the resulting flapping set upper limits on the safe travel speed. Travel speeds are finally limited by friction heating of the rubber track.

3. Description of Related Art

[Note: As used herein, the term rubber relates to any elastic and primarily non-metallic materials, such as rubber, elastomer, or combinations thereof used in the manufacture of belts].

Most rubber tracks are formed around a basic carcass or belt. The carcass includes an endless belt-shaped rubber-like elastic member, a number of core bars (usually of metal) embedded therein, aligned in the longitudinal direction thereof, and extending in the traverse directions thereof. It also includes high tension strength cords embedded in the endless elastic member to surround the core bars circumferentially outward. For example, see U.S. Pat. Nos. 4,904,030 (Ono), 5,295,741 (Togashi et al), 5,511,869 (Edwards et al), and 6,241,327 (Gleasman).

Some have suggested the construction of endless rubber tracks using a plurality of interconnected polymeric modules. For example, see U.S. Pat. Nos. 4,861,120 (Edwards et al) and 5,005,922 (Edwards et al).

Terrain contacting lugs are formed integral with the exterior surface of this basic belt element. Known rubber tracks have large lugs in a variety of well-known orientations, such as those formed generally perpendicular to the track axis, at an angle to the track axis, or in a chevron or modified-chevron design. These latter specialized tracks also include interior lugs or horns for maintaining the track in alignment as it travels over the circumferences of the rubber tires. These lugs are located either in the center of the interior surface of the track (for fitting between the tires of dual wheels) or in two aligned rows near the outside edges of the track (for receiving a single tire there between). For example, see U.S. Pat. Nos. 5,447,365 (Muramastsu et al), and 5,540,489 (Muramatsu et al).

Endless rubber tracks have been adapted to existing high-speed military steel track laying vehicles to improve efficiency at higher road speeds. For example, see U.S. Pat. No. 2,357,140 (Soucy et al).

### OBJECTS AND ADVANTAGES

Spring rubber or pneumatic road tires 002 slightly larger in diameter than the endless rubber belt 004 are located beside the belt to laterally guide the endless rubber belt 004 and minimize track-throwing occurrences. Spring rubber or pneumatic tires absorb rough road shocks from stones and pot holes that might break solid wheels of similar strength. The side located road tires 002 act as large guides. However, unlike existing tracks, the guide horns 020 are not prone to grabbing loose debris and wedging the debris between the rubber belt 004 and the track tires 003. Loose debris wedged between rubber belt 004 and the track tires 003 can easily lift the rubber belt 004 off the track tires 003. The side shoulder of the road tire 002 is protected from track friction wear by a small gap present between the road tire 002 and the endless rubber belt 004 at full road tire 002 inflation and track the outside guide horns 020, which are designed to spread any lateral load against the tire over a large area. When the inflation of road tires 002 is sufficiently reduced, the track outside the guide horns 020 is designed to operate like a V-belt gripping both the track tires 003 and the road tires 002. Interior 3D curvilinear belt drive teeth 033 may be used to eliminate endless rubber belt slippage on track drive wheel. The 3D curvilinear drive teeth 033 allow much larger track wheel misalignments than conventional drive horns. However, in most applications, the tight endless rubber belt 004 on the track drive tire 031 should provide more than enough traction to prevent excessive slippage of the rubber belt 004. Slight rubber belt 004 slippage substantially reduces drive train shock forces. Eliminating the drive teeth 033 allows track drive wheels to dig through any debris that may have accumulated inside the endless rubber belt 004. As a result, debris, such as sticks and stones, cleans itself away much easier. The road tires 002 located beside the endless rubber belt 004 also protect the rubber belt 004 by clearing material away from the track while turning in soft soils or loose debris. On smooth hard surfaces, if fully inflated, the road tires 002 would lift the endless rubber belt 004 off the surface. The endless rubber belt 004 can be lifted off hard road surfaces during high speed travel, dramatically reducing wear and rolling friction. Higher road speeds with reduced power consumption are achieved by disengaging the rubber belt 004 during high speed operation. The rubber belt 004 would then be engaged when required by brakes between the track tires 003 and road tires 002. A tensioning idler is composed of tensioning track guides 006, tensioning shaft 007, and dual tensioning tires 015. Retracting the tensioning idler in combination with the slight ground clearance provided by the road tires 002 on hard surfaces can allow the rubber belt 004 to be removed and replaced without the use of vehicle jacks.

The outside road tires 002 prevent the rubber belt 004 from track-throwing even when the track tires 003 are misaligned. The optional interior 3D curvilinear drive teeth 033 and the track outside guide horns 020 are practically immune to realistic amounts of misalignment. With a pattern belt canvas, which allows for an amount of belt shear, the proposed hybrid tire rubber belt systems can be adapted to vehicles with a suspension not specifically designed for rubber belts. In such an application, a pivotable tensioning idler dynamically maintains uniform tension across the width of the rubber belt 004. The angular misalignment between tandem solid axis 001 is further reduced by a hydraulic linkage between them, which enables the hybrid tire and rubber belt system to be used on many existing tire vehicles.

### SUMMARY

In accordance with the present invention, a belt is used in conjunction with road wheels to support weight of hybrid wheel track-laying vehicles. This is an improved design that allows a belt to be driven more efficiently and safely at highway speeds, diminishes the possibility of mud, sand, or other debris dislodging the track during turning maneuvers, and reduces belt wear when this invention is used on hard surfaces.

### DRAWING FIGURES

FIG. 1 is an isometric view of rubber belt assembly for dual track tires.

FIG. 2 is a front view of rubber belt assembly for dual track tires showing the position of cutting plane A-A.

FIG. 3 is a cross section of rubber belt assembly for dual track tires at cutting plane A-A.

FIG. 4 is a side view of rubber belt assembly for dual track tires showing the position of cutting planes B1-B1, B2-B2, B3-B3, and B4-B4.

FIG. 5 is an end view of rubber belt assembly for dual track tires at cutting plane B1-B1.

FIG. 6 is an end view of rubber belt assembly for dual track tires at cutting plane B2-B2.

FIG. 7 is an end view of rubber belt assembly for dual track tires at cutting plane B3-B3.

FIG. 8 is an end view of rubber belt assembly for dual track tires at cutting plane B4-B4.

FIG. 9 is a front view of rubber belt frame for dual track tires with rubber belt removed.

FIG. 10 is a top view of rubber belt frame for dual track tires with rubber belt removed.

FIG. 11 is a side view with dual tire rubber belt for over dual track tires showing the positions of cutting plane C2-C2 and cut object C1-C1.

FIG. 12 is a front view of one single rubber belt unit at cut object C1-C1.

FIG. 13 is a top view of one single rubber belt unit at cut object C1-C1.

FIG. 14 is a rear view of one set of rubber belt unit at cutting plane C2-C2.

FIG. 15 is an isometric view of rubber belt assembly for single track tire twisted 8 degrees.

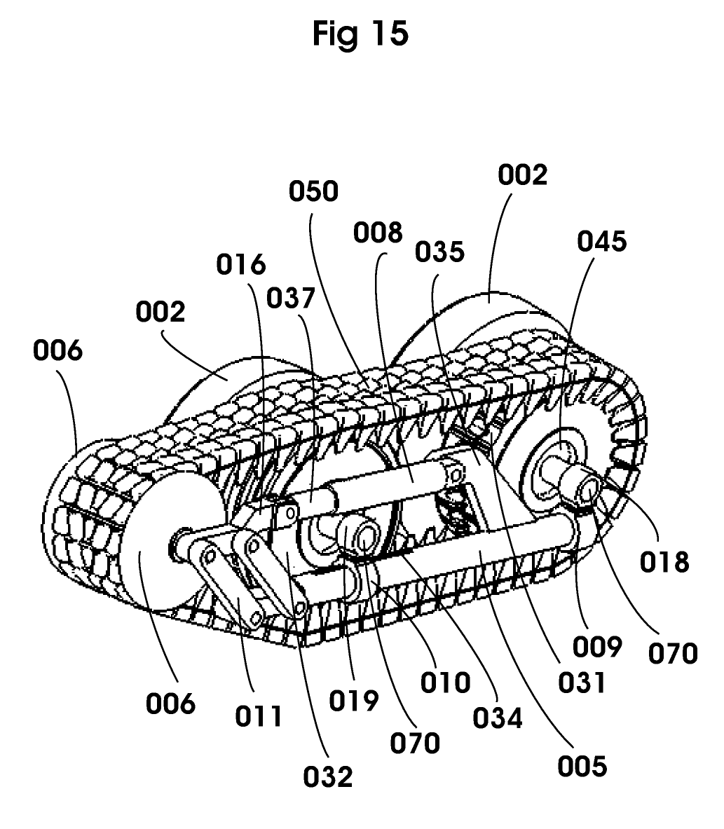

FIG. 16 is a front view of rubber belt assembly for single track tire twisted 8 degrees.

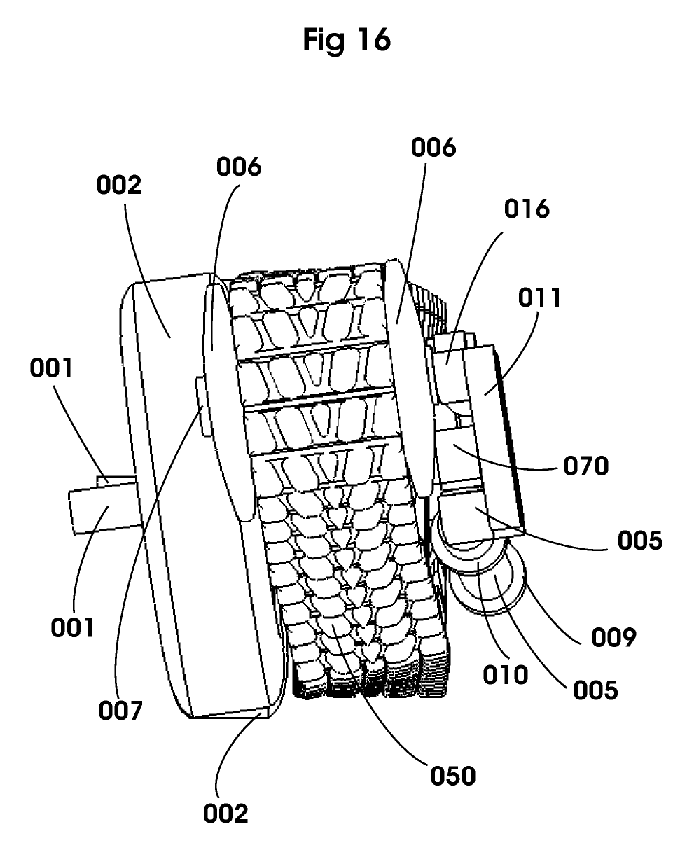

FIG. 17 is a top view of rubber belt assembly for single track tire side twisted 8 degrees.

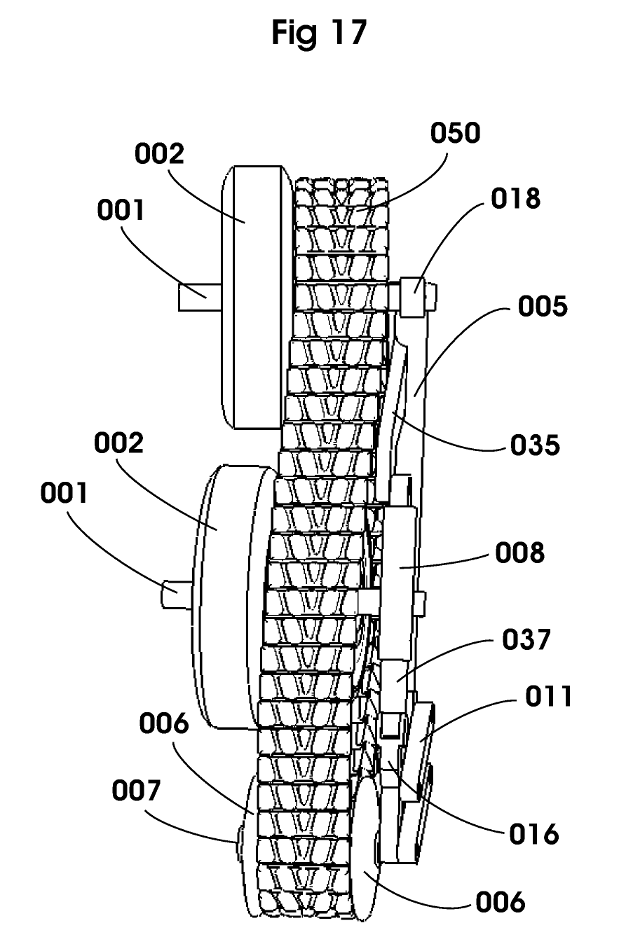

FIG. 18 is a side view of rubber belt assembly showing the positions of cutting planes D1-D1, D2-D2, D3-D3, D4-D4, and D5-D5.

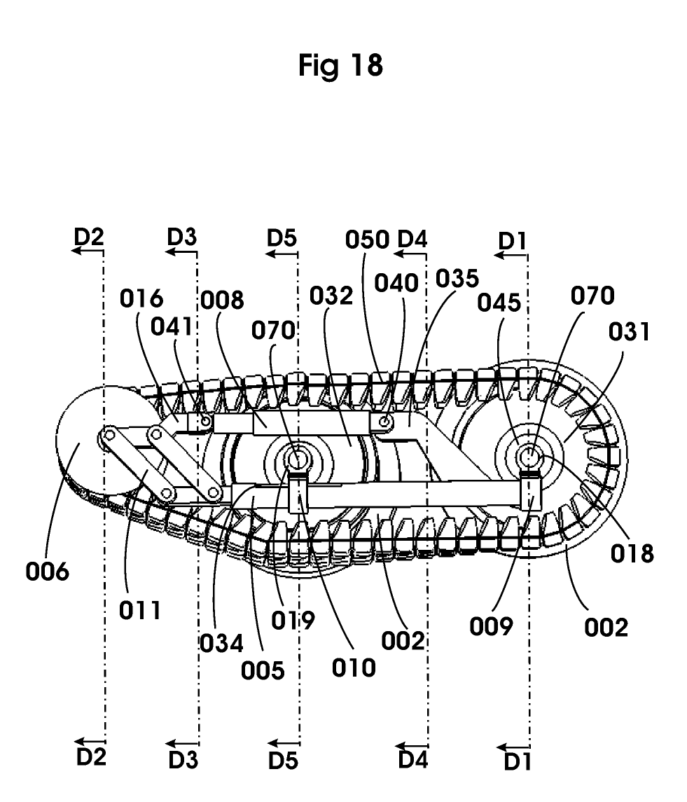

FIG. 19 is an end view of rubber belt assembly for single track tire at cutting plane D1-D1.

FIG. 20 is an end view of rubber belt assembly for single track tire at cutting plane D2-D2.

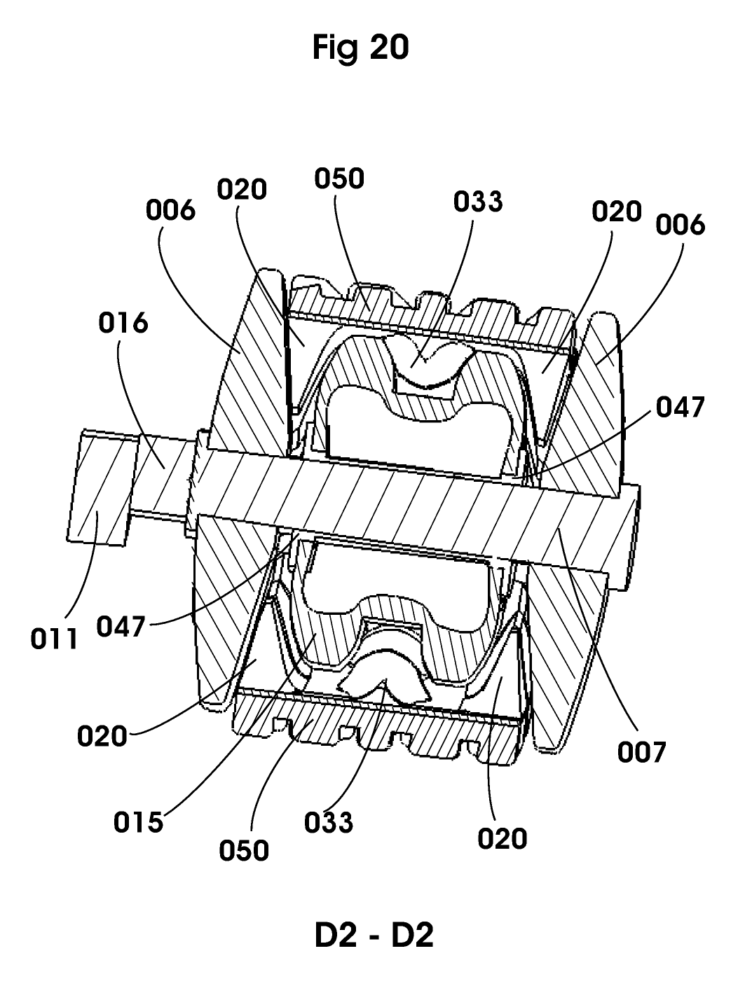

FIG. 21 is an end view of rubber belt assembly for single track tire at cutting plane D3-D3.

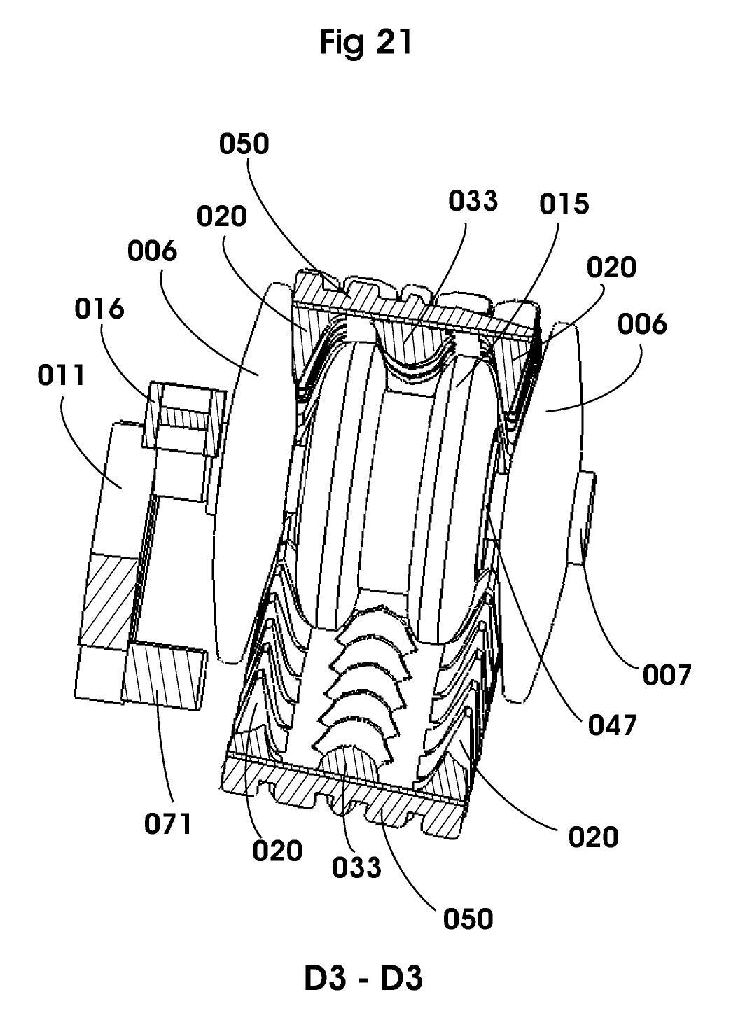

FIG. 22 is an end view of rubber belt assembly for single track tire at cutting plane D4-D4.

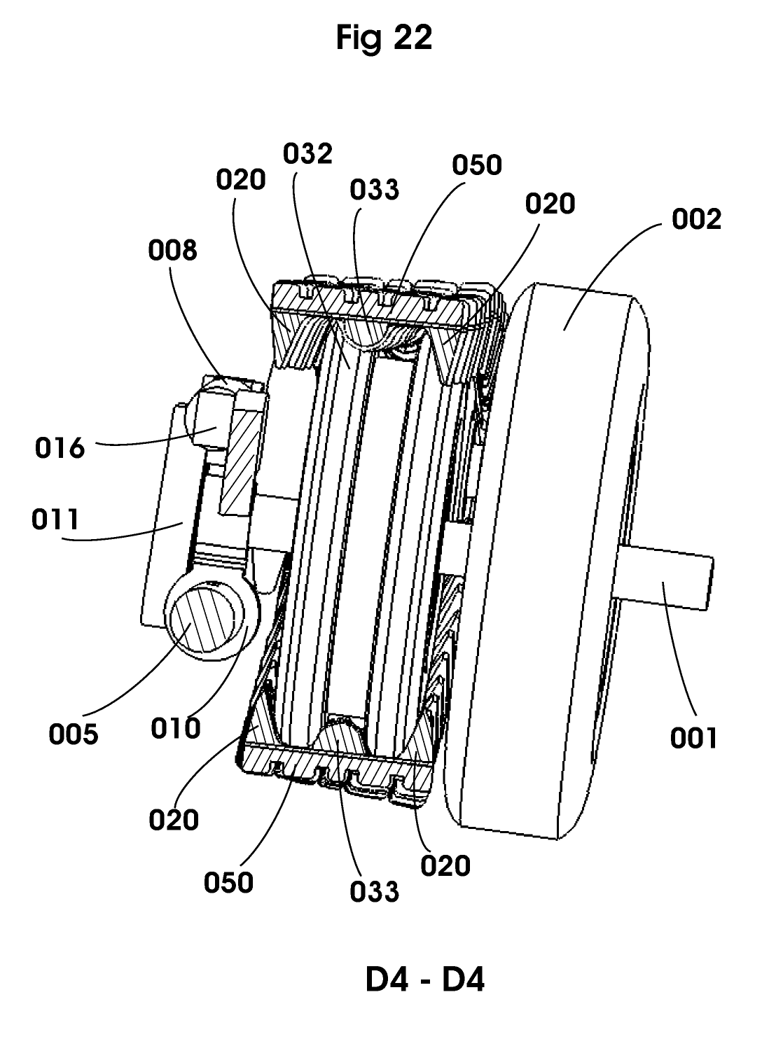

FIG. 23 is an end view of rubber belt assembly for single track tire at cutting plane D5-D5.

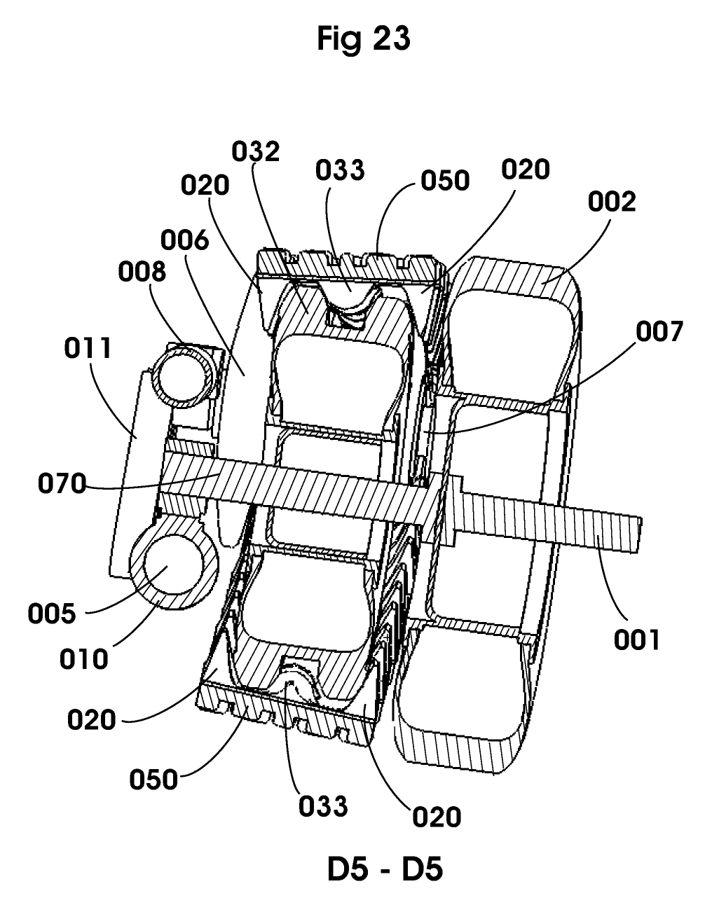

FIG. 24 is a front view of rubber belt assembly for single track tire with rubber belt removed twisted 8 degrees.

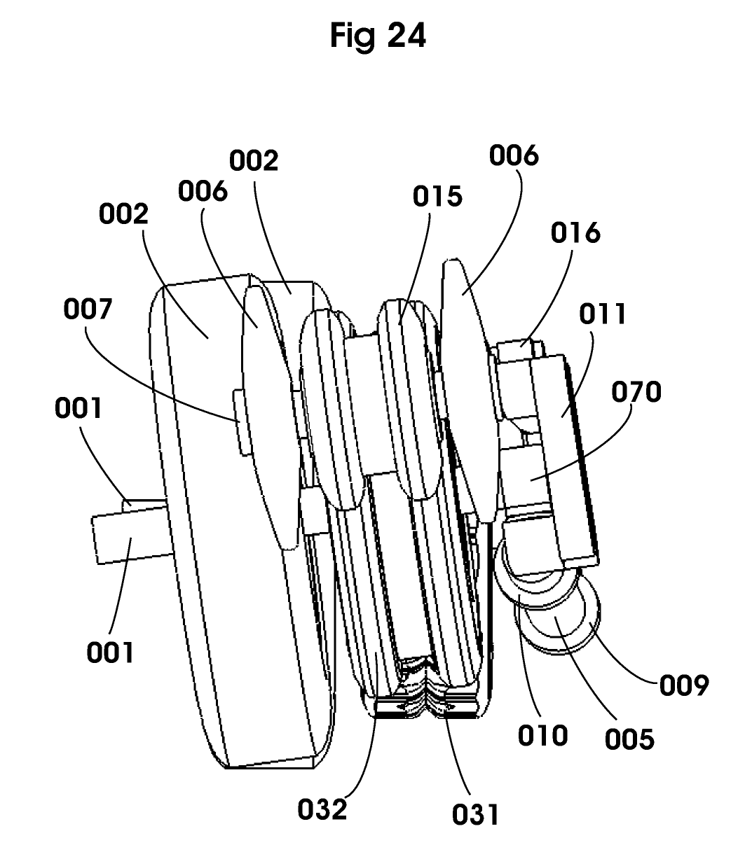

FIG. 25 is a top view of rubber belt assembly for single track tire with rubber belt removed twisted 8 degrees.

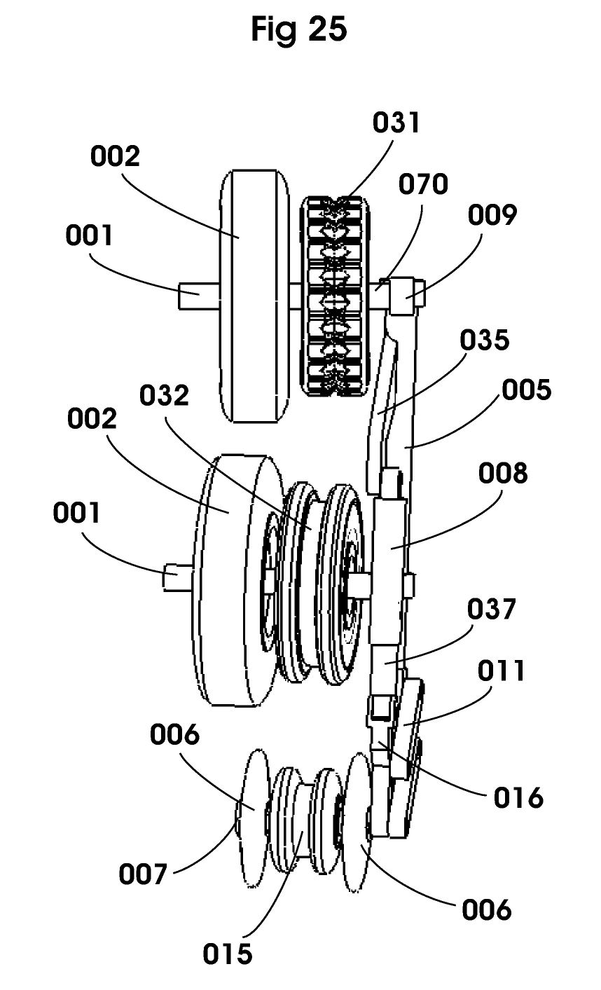

FIG. 26 is an isometric view of belt tooth.

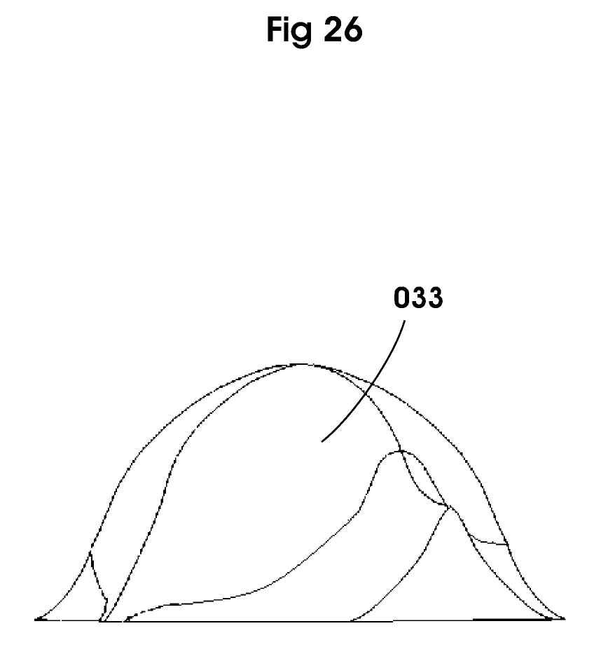

FIG. 27 is an isometric view of rubber belt assembly for single track tire.

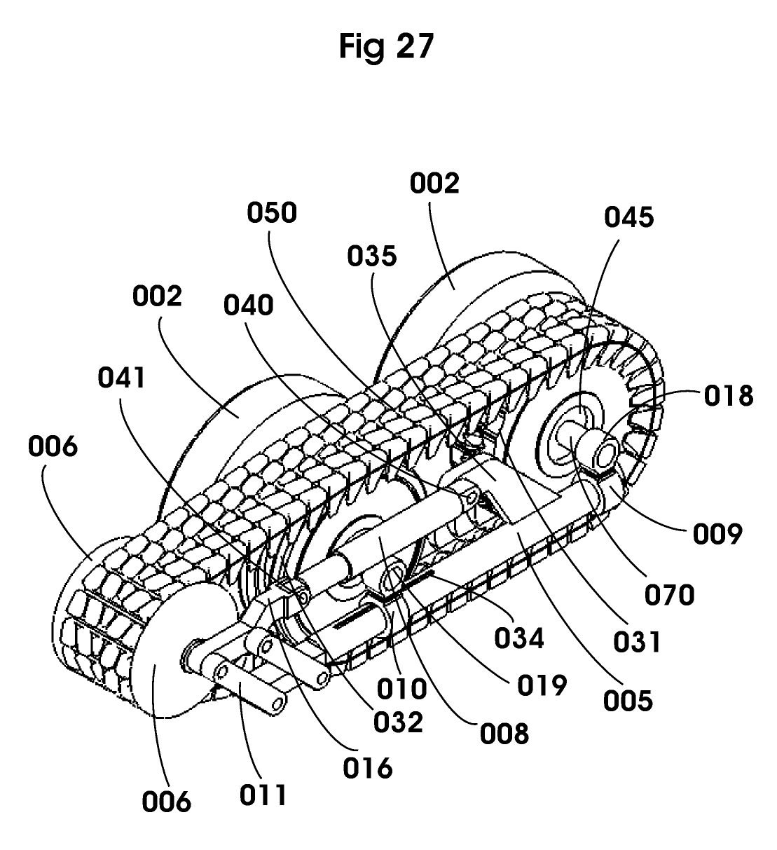

FIG. 28 is a front view of rubber belt assembly for single track tire.

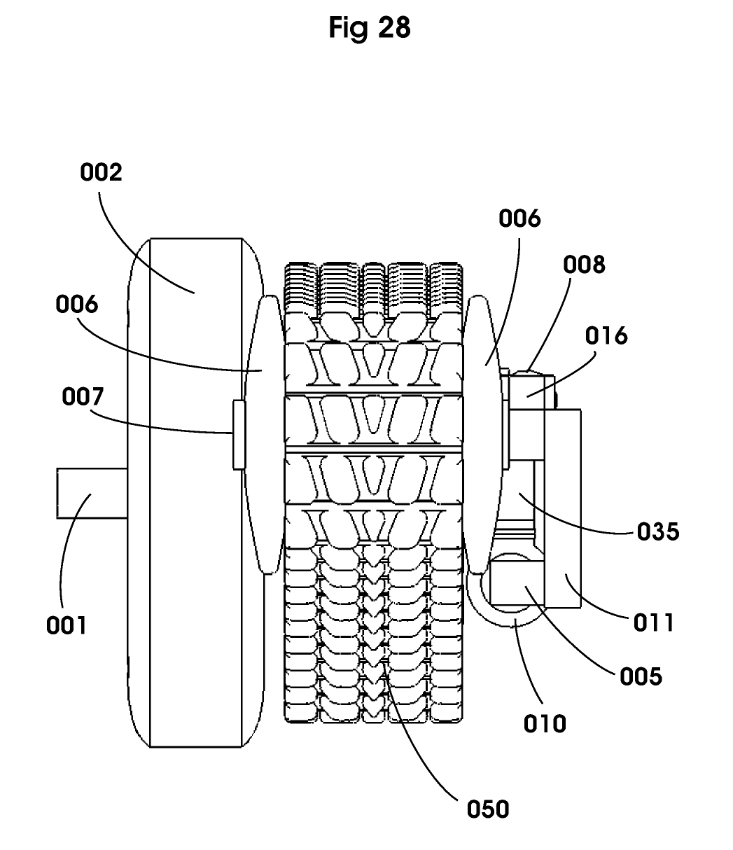

FIG. 29 is a top view of rubber belt assembly for single track tire.

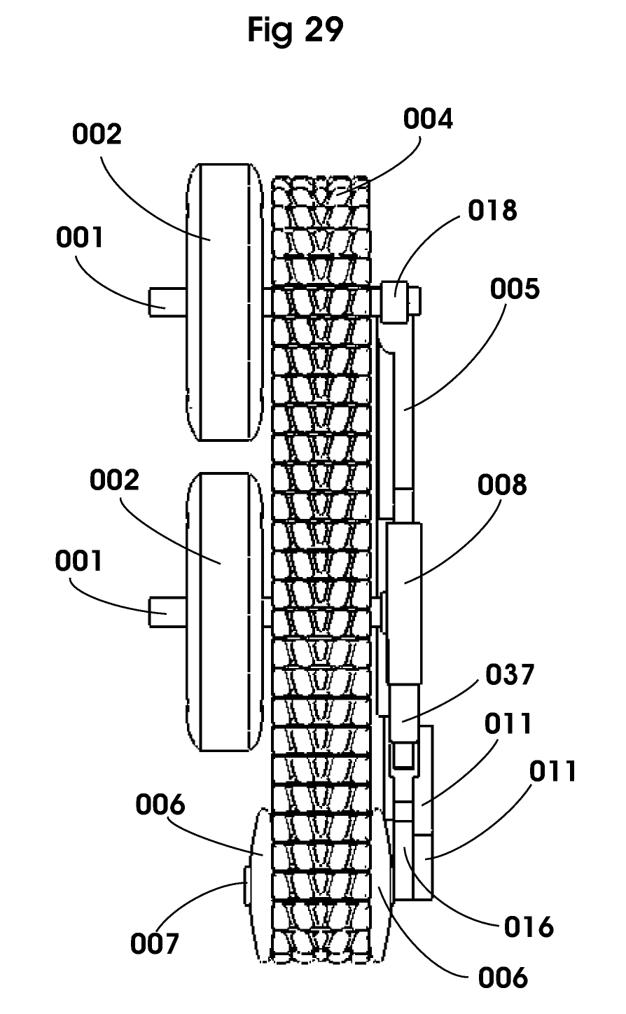

FIG. 30 is a side view of rubber belt assembly for single track tire showing the positions of all cutting planes E1-E1, E2-E2, E3-E3, E4-E4, and E5-E5.

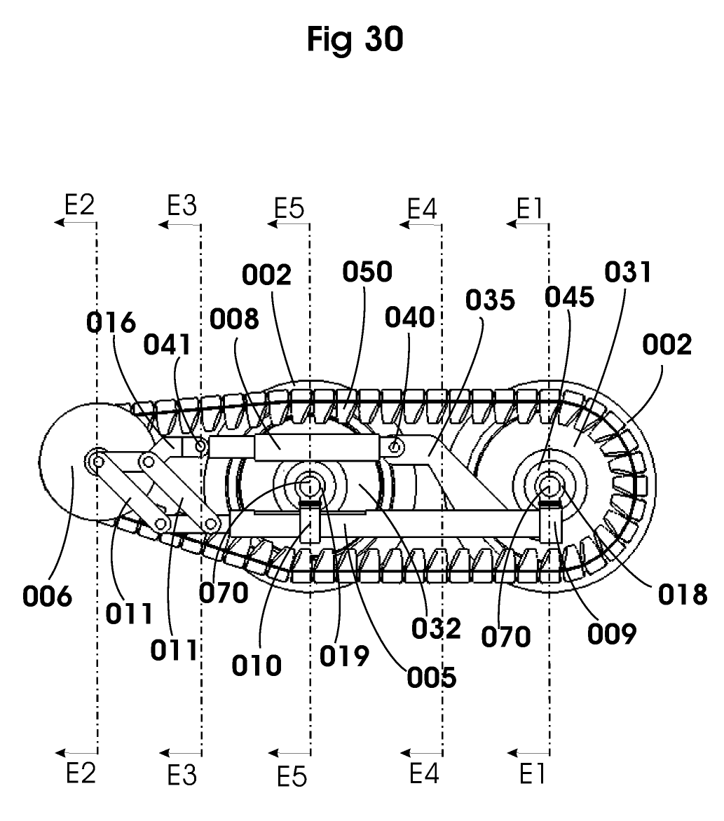

FIG. 31 is an end view of rubber belt assembly for single track tire at cutting plane E1-E1.

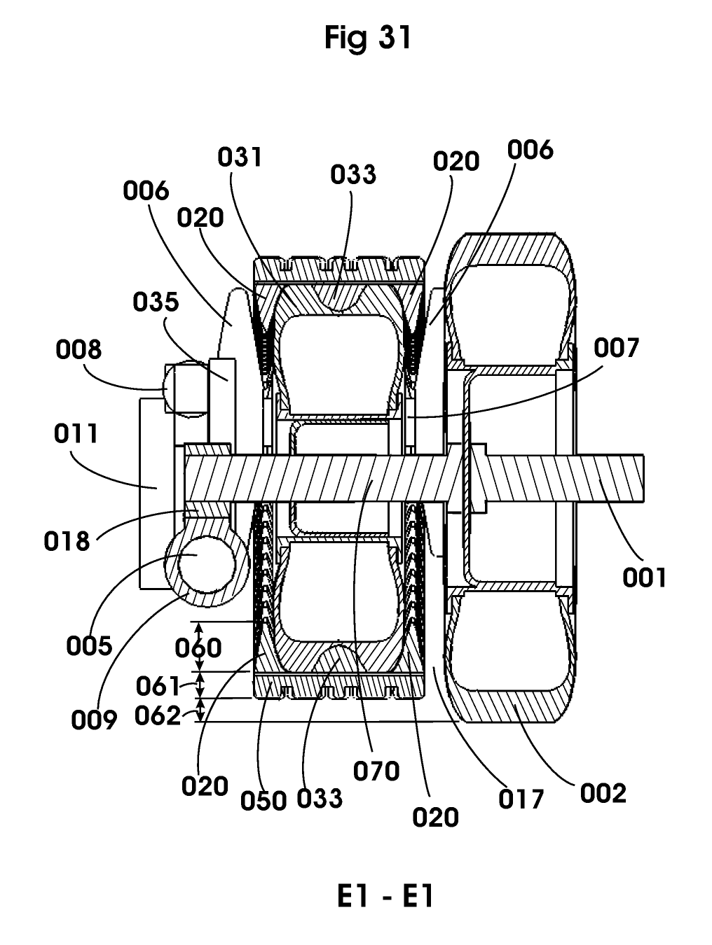

FIG. 32 is an end view of rubber belt assembly for single track tire at cutting plane E2-E2.

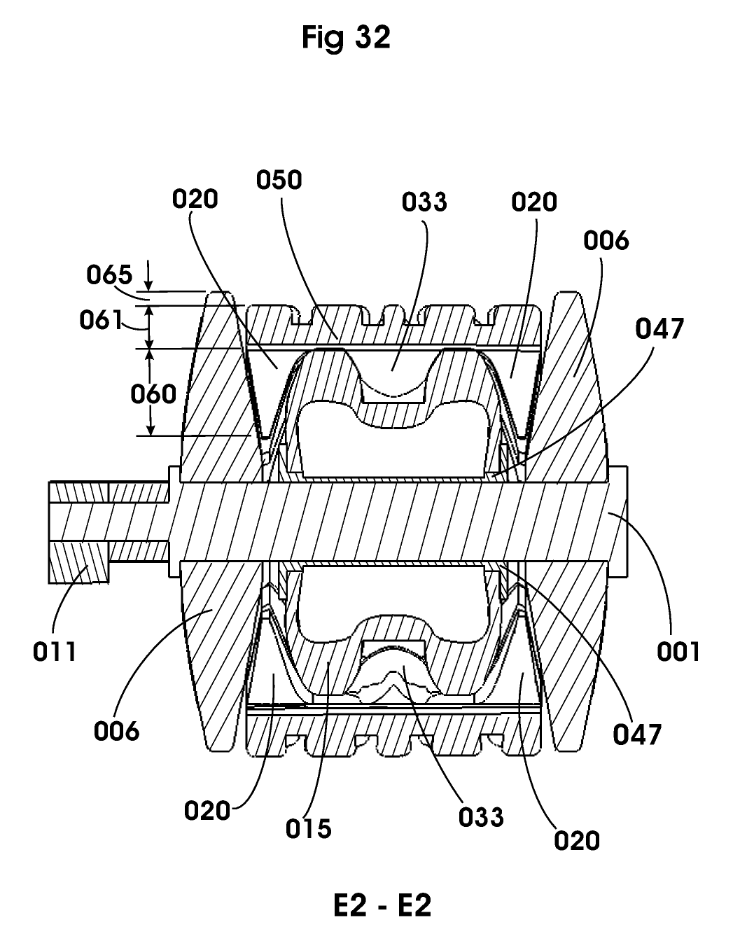

FIG. 33 is an end view of rubber belt assembly for single track tire at cutting plane E3-E3.

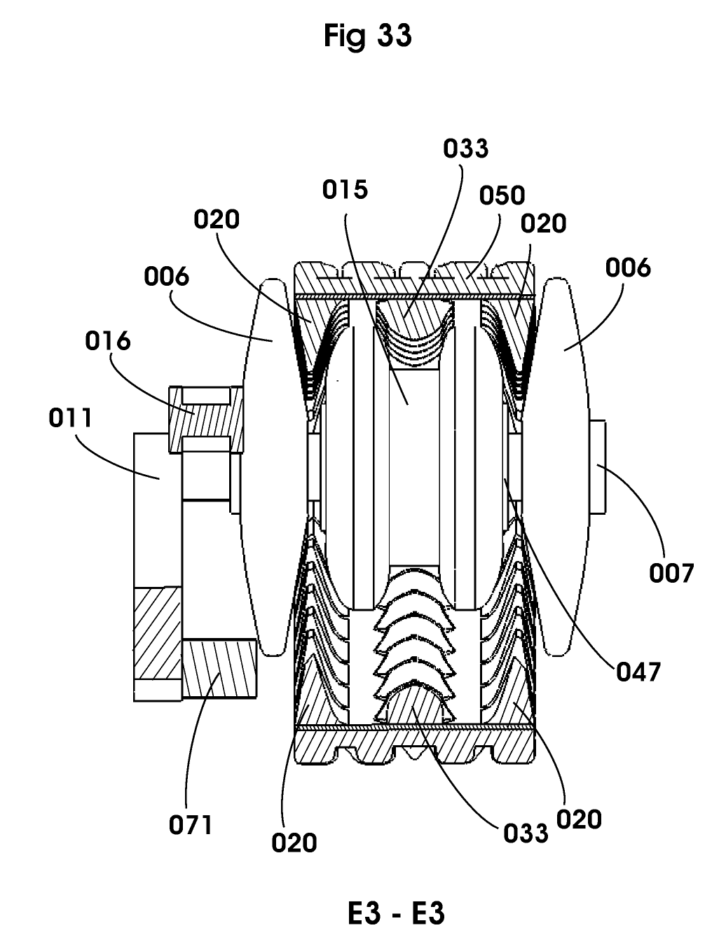

FIG. 34 is an end view of rubber belt assembly for single track tire at cutting plane E4-E4.

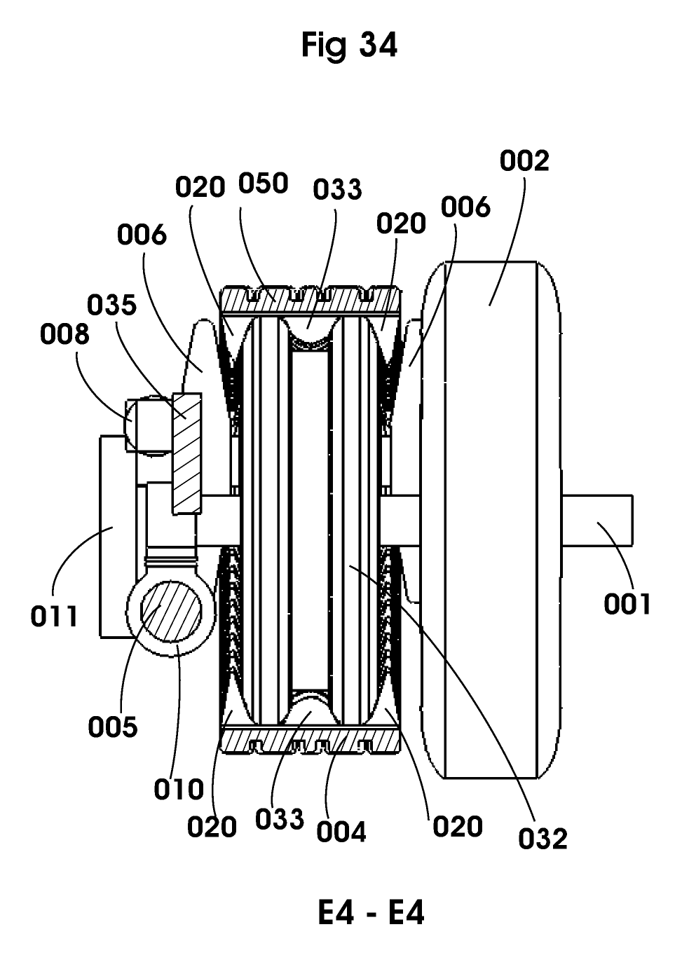

FIG. 35 is an end view of rubber belt assembly for single track tire at cutting plane E5-E5.

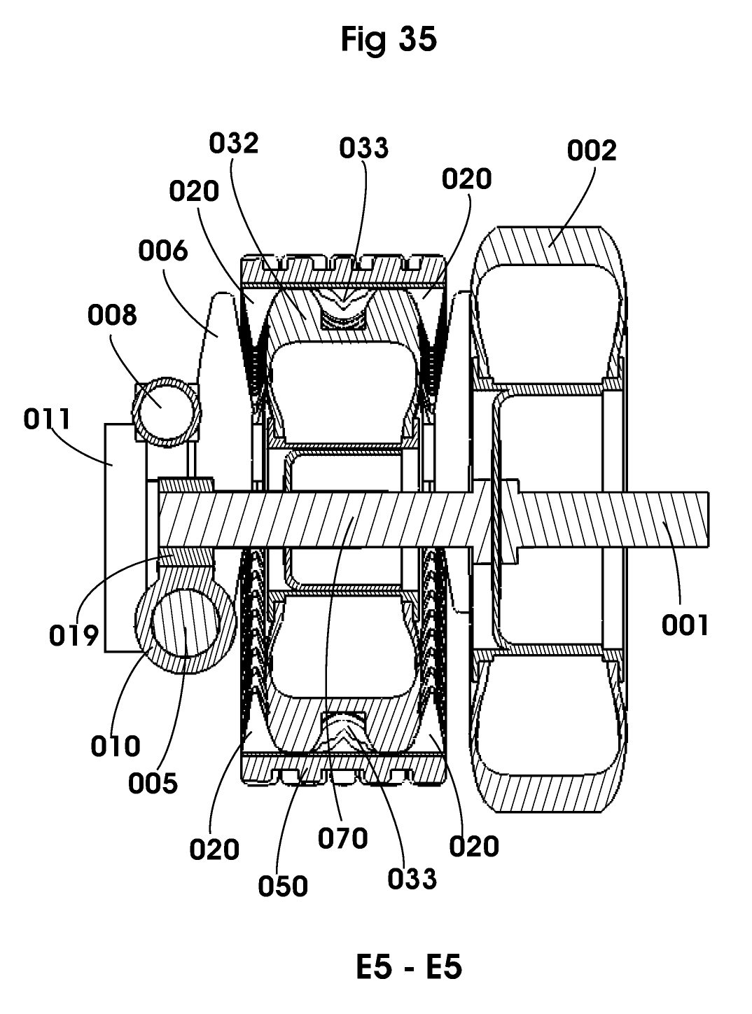

FIG. 36 is a front view of rubber belt frame for single track tire with rubber belt removed.

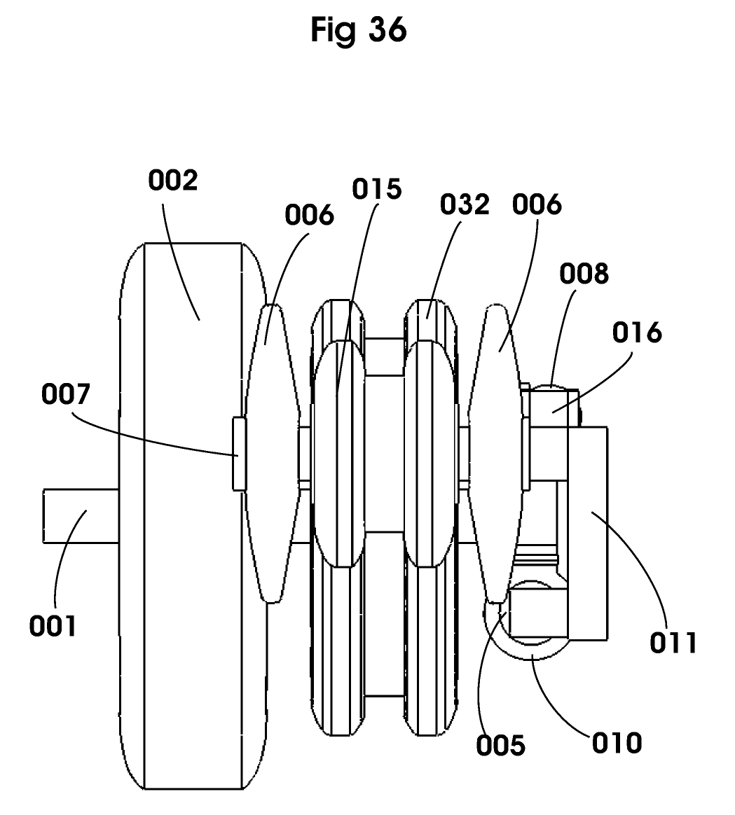

FIG. 37 is a top view of rubber belt frame for single track tire with rubber belt removed.

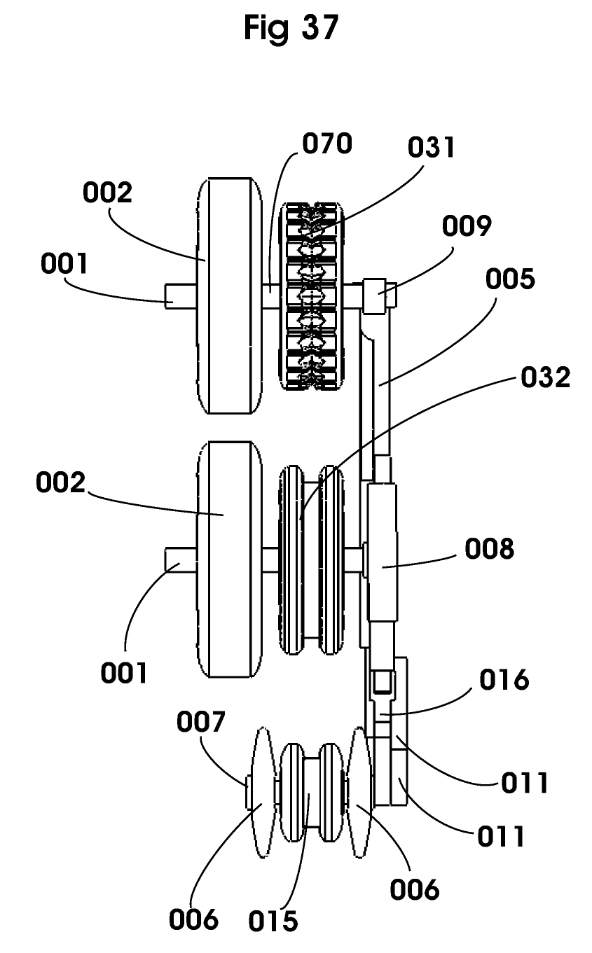

FIG. 38 is a side view of rubber belt showing the positions of cutting plains F1-F1 and F2-F2.

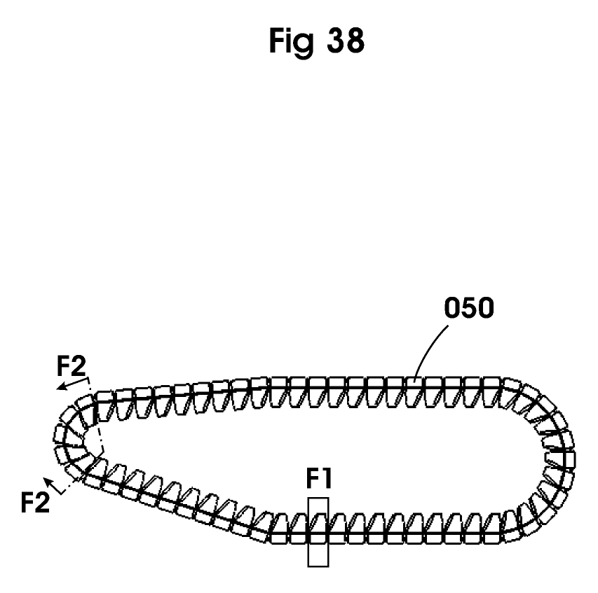

FIG. 39 is the end view of a rubber belt unit at cutting plane F1-F1 looking along the length of the rubber belt.

FIG. 40 is the inside view of rubber belt unit at cutting plane F1-F1.

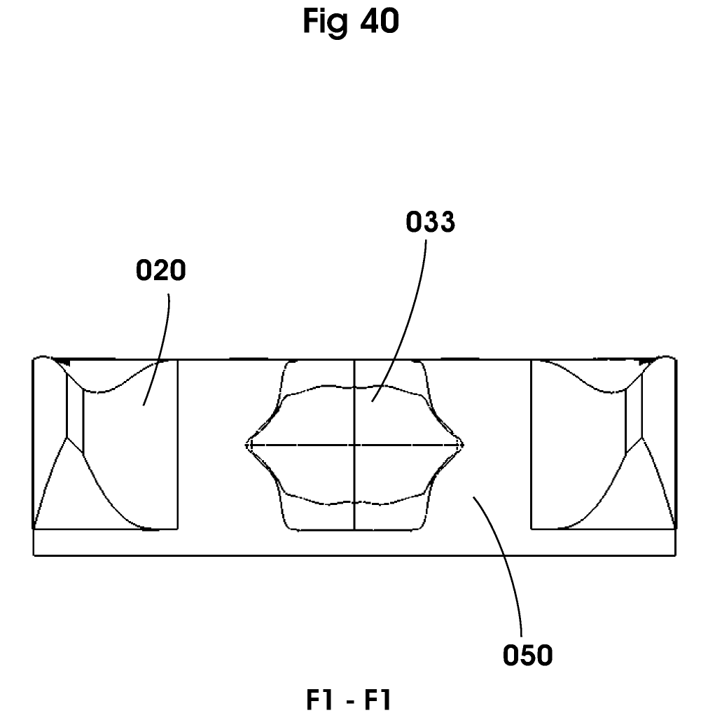

FIG. 41 is the inside view of rubber belt bending at cutting plane F2-F2.

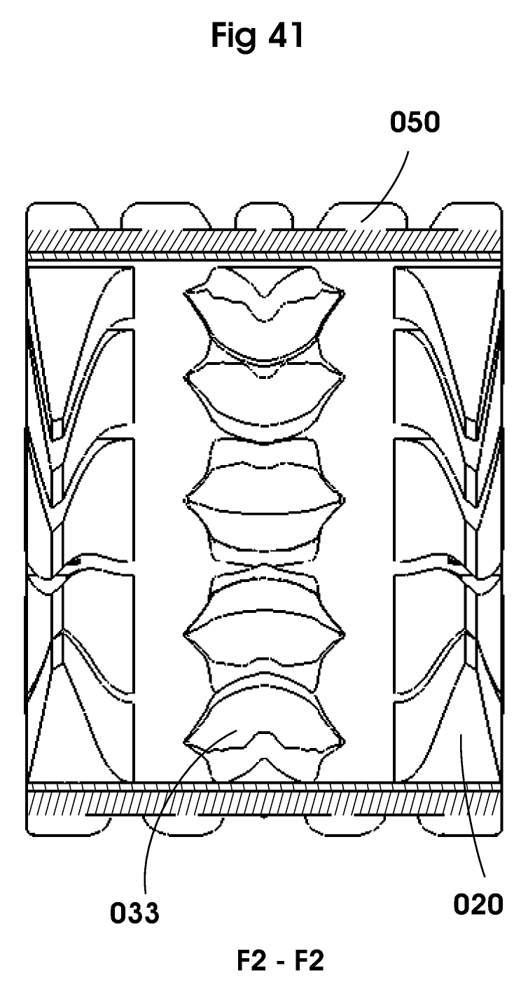

### REFERENCE CHARACTERS IN DRAWINGS

001 axle shaft
002 road tires
003 dual track tires
004 dual tire rubber belt
005 rear track frame
006 tensioning track guide
007 tensioning shaft
008 track hydro-pneumatic cylinder
009 track frame pivot joint
010 track frame slide joint
011 track frame parallelogram
012 track frame tensioning pivot joint
013 road wheel rim
014 dual track wheel rim
015 dual tensioning tires
016 track hydro-pneumatic push rod
017 gap between road tire and rubber belt
018 rear axle joint
019 front axle joint
020 rubber belt guide horns
021 rubber belt guide horns outer edge
022 rubber belt guide horns inner edge
023 rubber belt tread
024 belt
025 rubber belt guide horns front
026 rubber belt guide horns back
027 rubber belt wheel runway
028 rubber belt center runway
029 vertex of rubber belt guide horn
030 rubber belt guide horn gap
031 single drive track tire
032 single track tire
033 drive tooth
034 key way
035 track frame arm
036 tensioning pivot joint
037 track hydro-pneumatic piston
038 dual tensioning wheel rim
040 cylinder rear hinge joint
041 cylinder front hinge joint
045 single track wheel rim
047 single tensioning wheel rim
050 single tire rubber belt
060 rubber belt guide horn height
061 rubber belt tread depth
062 rubber belt road clearance
063 angle from vertical of the rubber belt guide horns outer edge 021
064 angle from vertical of the rubber belt guide horns inner edge 022
065 rubber belt tensioning guide clearance depth
070 axle extension
071 front track frame

### DESCRIPTION

During high speed road travel, the road tires are better suited for high speed operation. To reduce rubber belt 004 wear, rolling resistance and heat build up, the rubber belt 004 may be disengaged during road usage. To allow the rubber belt 004 to be disengaged for road travel, one or more of the axles shafts 001 needs to be driven. The axle shafts 001 are equipped with suspension for road and off road travel.

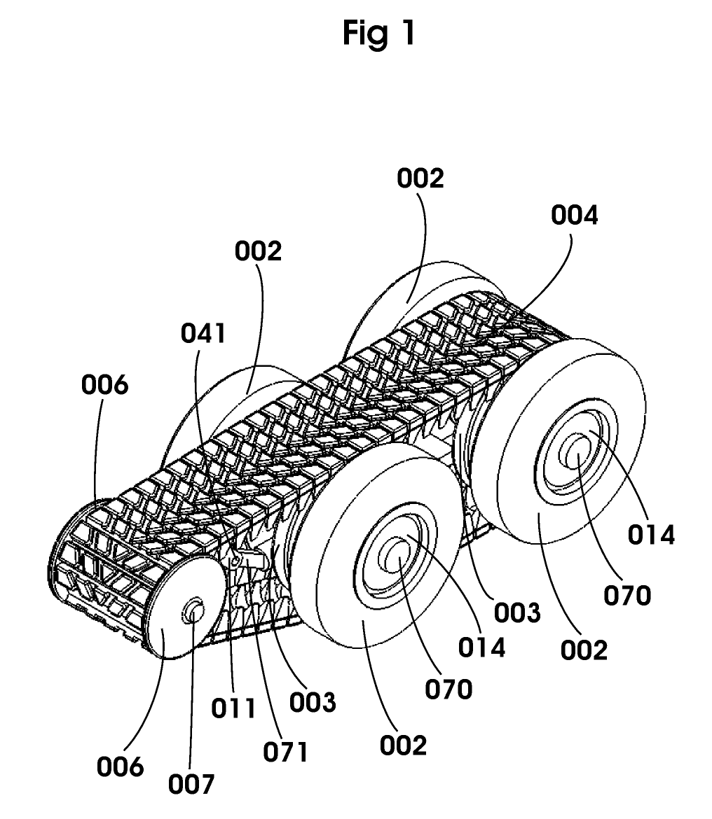

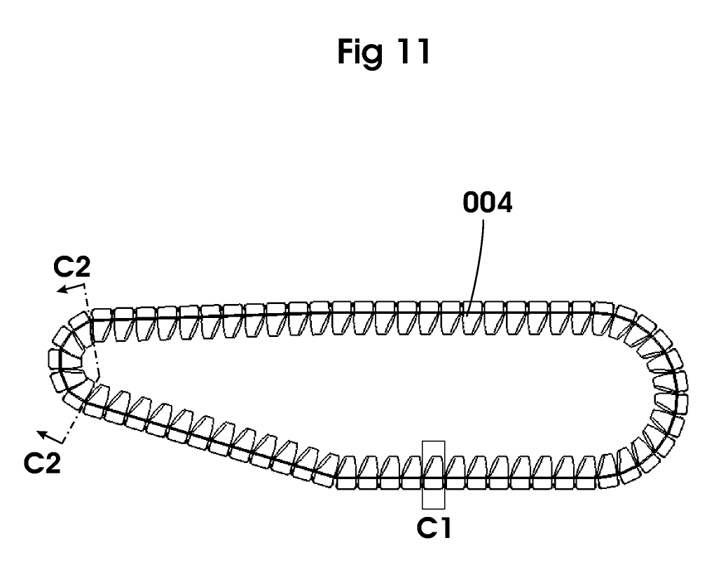

The complete dual tire hybrid rubber belt assembly is shown in FIGS. 1, 2, 3, 4, 5, 6, 7, 8, 9 and 10. The dual tire rubber belt 004 used on the dual tire hybrid rubber belt assembly is shown in FIGS. 11, 12, 13, and 14.

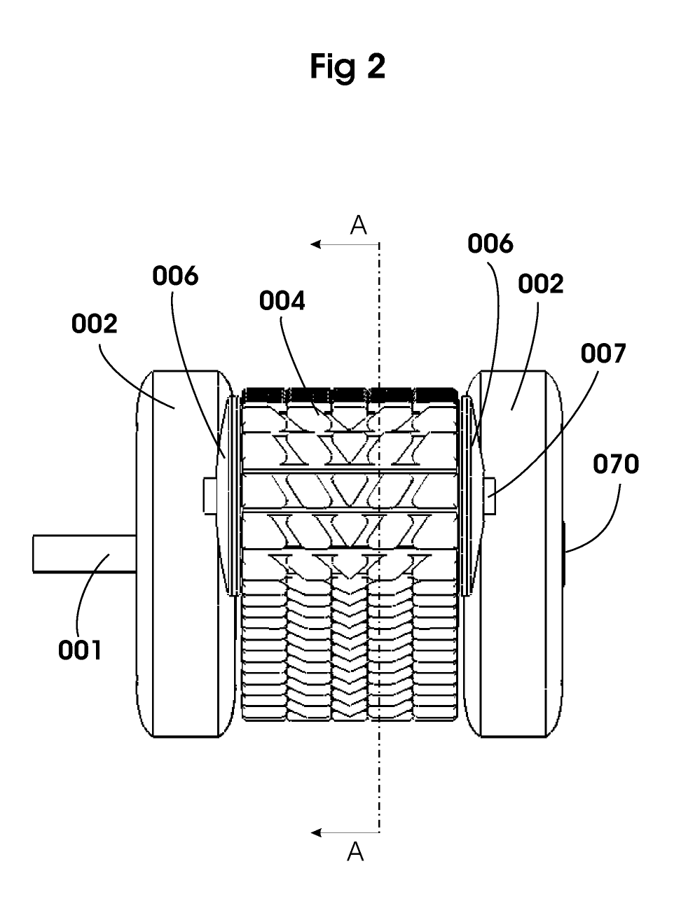

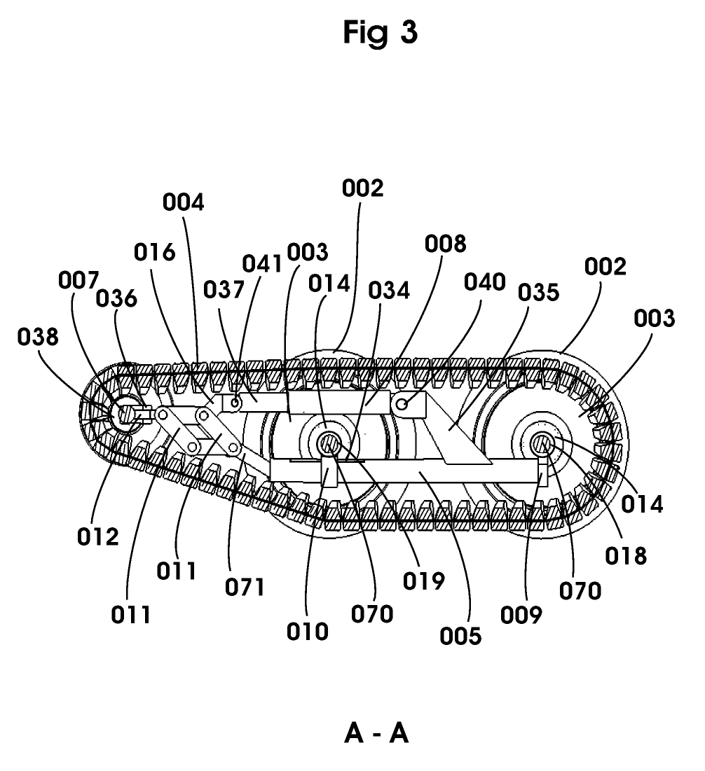

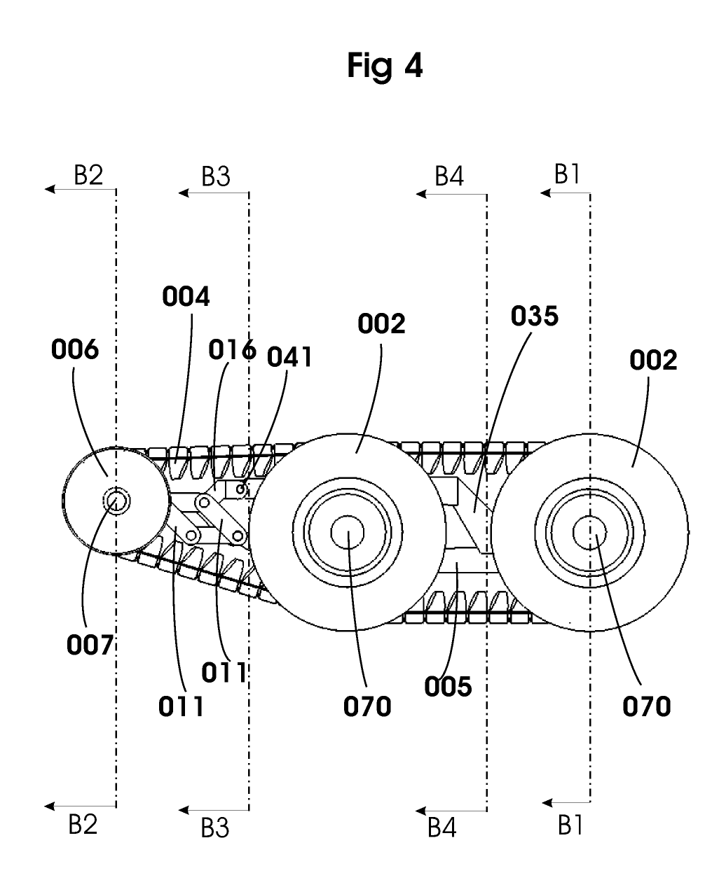

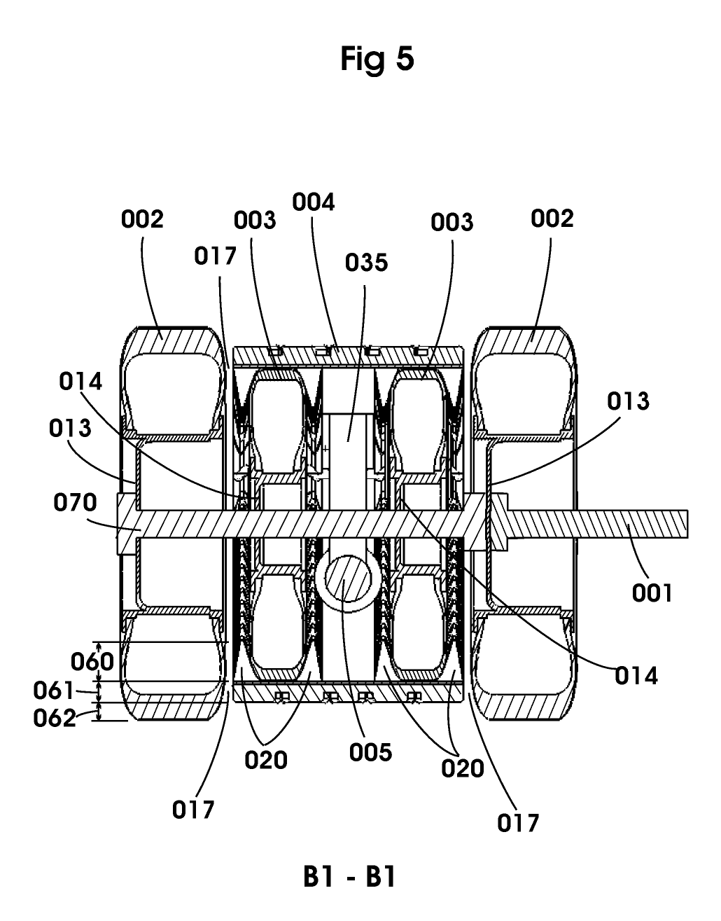

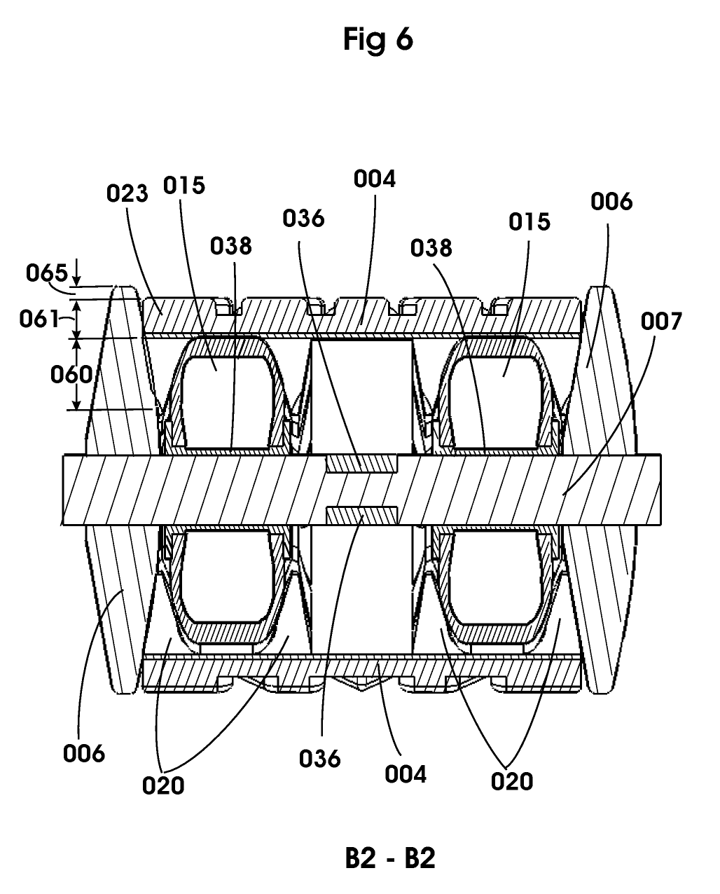

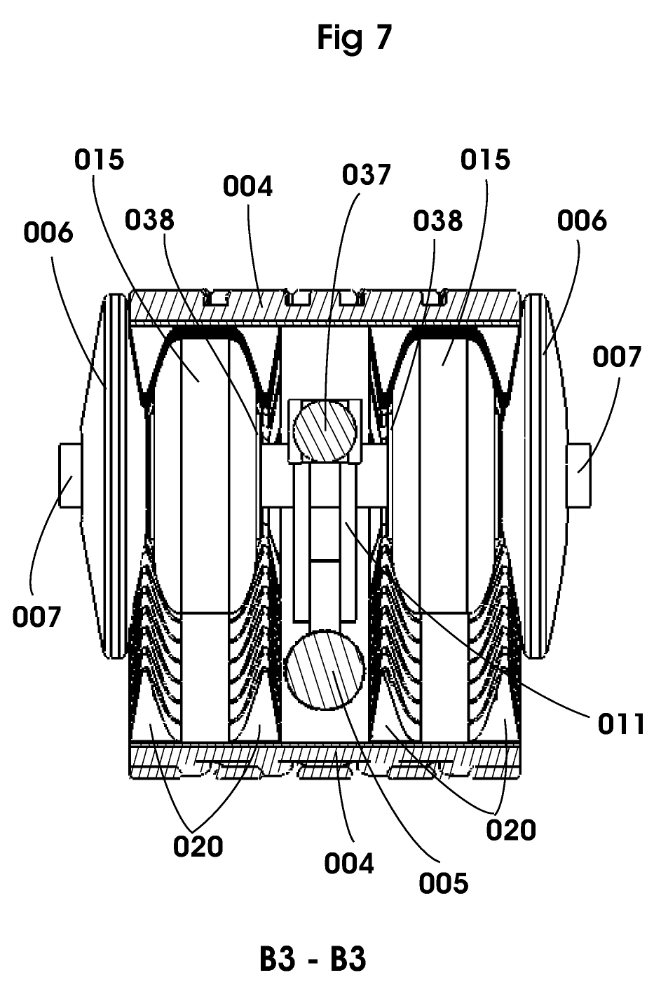

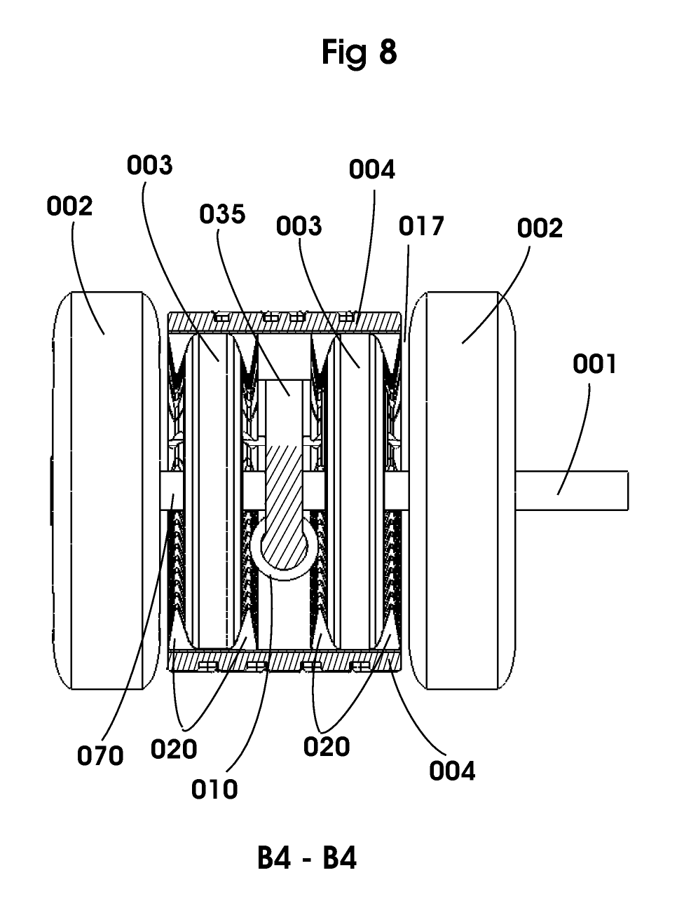

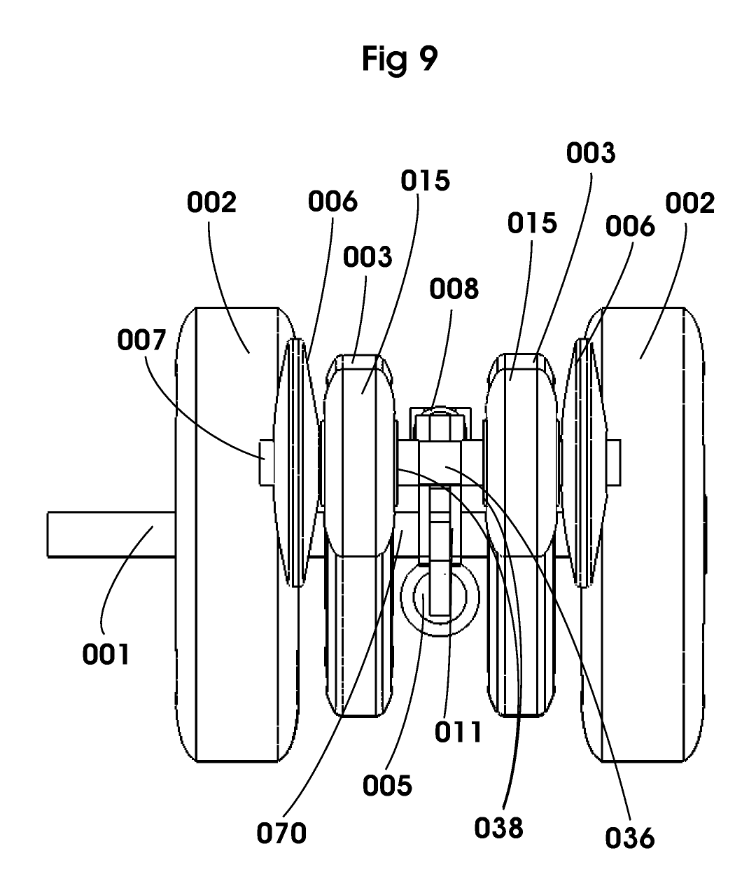

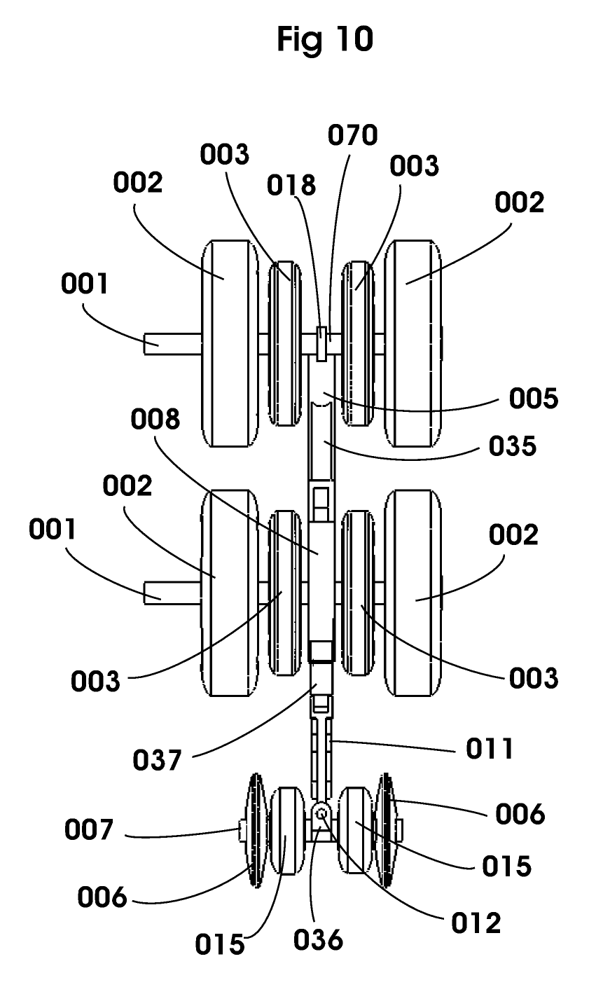

FIG. 1 shows an isometric view of the complete dual tire hybrid rubber belt assembly. FIG. 10 is the top view of dual tire hybrid rubber belt assembly with the dual tire rubber belt 004 removed from the complete assembly shown in FIG. 1. FIG. 9 is the front view of the dual tire hybrid rubber belt assembly with the dual tire rubber belt 004 removed. With the dual tire rubber belt 004 removed, the internal components are clearly visible in FIG. 10. FIG. 2 shows the front view of the complete dual tire hybrid rubber belt assembly. A cutting plane A-A, is shown in FIG. 2. The cutting plane A-A looking inwards towards the vehicle body, is taken between the outside track tire 003 and the track frame 005. FIG. 3 shows the side view of the complete dual tire hybrid rubber belt assembly taken along the cutting plane A-A. FIG. 4 shows the outside view of the complete dual tire hybrid rubber belt assembly. Cutting planes B1-B1, B2-B2, B3-B3 and B4-B4 are shown in FIG. 4. Cutting plane B1-B1 is taken through the rear axle shaft 001 looking forward to the front. FIG. 5 shows the rear view of the complete dual tire hybrid rubber belt assembly taken along the cutting plane B1-B1. Cutting plane B2-B2 is taken through the front tensioning shaft 007 looking forward to the front. FIG. 6 shows the rear view of the complete dual tire hybrid rubber belt assembly taken along the cutting plane B2-B2. Cutting plane B3-B3 is taken through just in front of the front road tires 002 looking forward to the front. FIG. 7 shows the rear view of the complete dual tire hybrid rubber belt assembly taken along the cutting plane B3-B3. Cutting plane B4-B4 is taken through just in front of the rear road tires 002 looking forward to the front. FIG. 8 shows the rear view of the complete dual tire hybrid rubber belt assembly taken along the cutting plane B4-B4.

### Frame Construction

The complete dual tire hybrid rubber belt assembly shown in FIGS. 1, 2, 3, 4, 5, 6, 7, 8, 9 and 10 is assembled as follows.

As shown in FIG. 10, the rear axle joint 018 is mounted on the rear axle shaft extension 070 and the front joint 019 shown in FIG. 3 is mounted on the front axle shaft extension 070 so that they are aligned to each other. As shown in FIG. 3, the track frame pivot joint 009 is attached to the rear axle joint 018. The track frame slide joint 010 is attached to the front axle joint 019. The track frame 005 is fixed at the track frame pivot joint 009 so that it goes through the track frame slide joint 010 with the key-way 034 facing upwards. A key is placed on the key-way 034 to prevent the track frame 005 from twisting.

As shown in FIG. 3, the track frame arm 035 is attached to top of rear track frame 005 between the track frame pivot joint 009 and the track frame sliding joint 010. The hydro-pneumatic cylinder 008 is attached to the track frame arm 035 by cylinder rear hinge joint 040. The front of the hydro-pneumatic piston 037 is attached to the hydro-pneumatic push rod 016 by the cylinder front hinge joint 041. The hydro-pneumatic push rod 016 is connected to the tensioning shaft 007 by the tensioning pivot joint 036. The front track frame 071 is bolted onto the rear track frame 005 in front of the front axle extension 070. The hydro-pneumatic push rod 037 is connected to the front track frame 071 by the track parallelogram 011.

As shown in FIG. 5, the rear dual track wheel rims 014 are mounted on the rear axle shaft extension 070 both sides of the rear track frame 005. The rear dual track wheel rims 014 are mounted by either bolted directly onto the rear axle shaft extension 070 or bolted to a brake assembly which is in turn bolted onto the rear axle shaft extension 070.

The front dual track wheel rims 014 are mounted on the front axle shaft extension 070 both sides of the rear track frame 005 which is aligned with the rear dual track wheel rims 014. The front dual track wheel rims 014 are mounted by either bolted directly onto the front axle shaft extension 070 or bolted to a brake assembly which is in turn bolted onto the front axle shaft extension 070. The front dual track tires 003 are mounted onto the front dual track wheel rims 014. The rear dual track tires 003 are mounted onto the rear dual track wheel rims 014.

As shown in FIG. 5, the inside rear road wheel rim 013 is bolted onto the rear axle shaft 001. The rear axle extension 070 is bolted through the inside rear road wheel rim 013 onto the rear axle shaft 001. The inside front road wheel rim 013 is bolted onto the front axle shaft 001 and is aligned with the inside rear road wheel rim 013. The front axle extension 070 is bolted through the inside front road wheel rim 013 onto the front axle shaft 001. The outside rear road wheel rim 013 is bolted onto the rear axle shaft extension 070. The outside front road wheel rim 013 is bolted onto the front axle shaft extension 070 and is aligned with the outside rear road wheel rim 013. The front and rear road wheel rims 013 are located on both sides of the front and dual track tires 003. The road tires 002 are mounted on all road wheel rims 013.

As shown in FIG. 6, the tensioning wheel rims 038 are mounted on the tensioning shaft 007 so that they are aligned with the front and rear dual track tires 003. The tensioning tires 015 are mounted onto the tensioning wheel rims 038. The tensioning guide 006 are mounted on the tensioning shaft 007, outside of the tensioning tires 015. The idle guides 006 align with the dual tire rubber belt 004 so that the dual tire rubber belt 004 runs between them.

### Track Construction

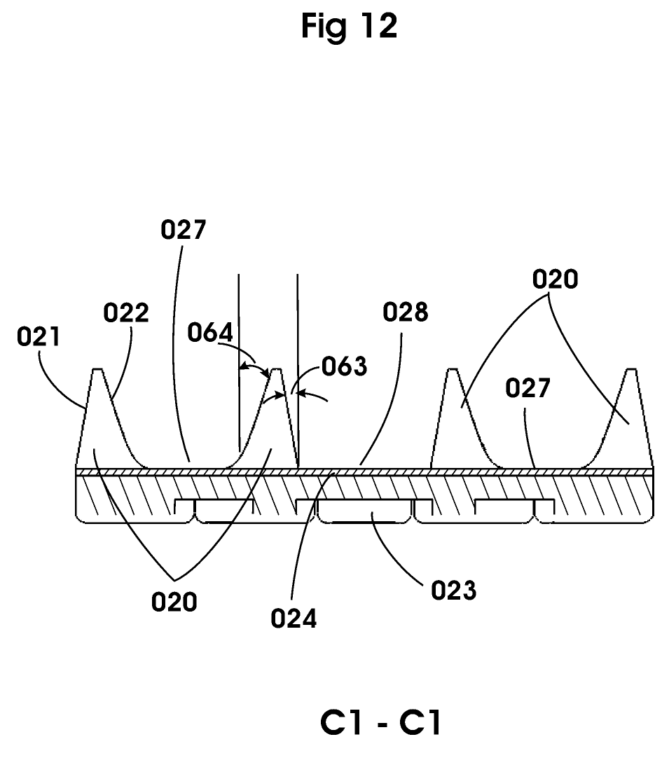

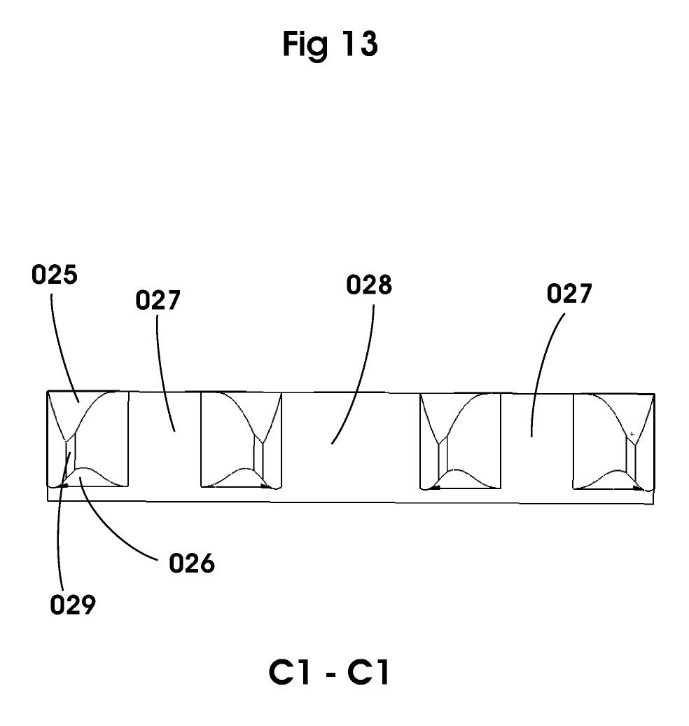

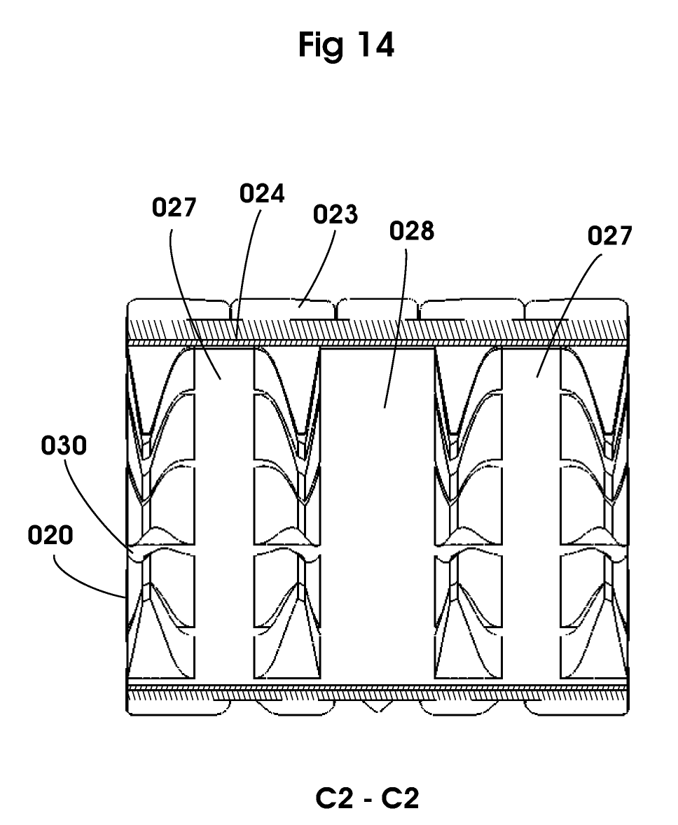

FIG. 11 shows the dual tire rubber belt 004. Cutting planes C1-C1 and C2-C2 are shown on FIG. 11. The cutting plane C1-C1 cuts around one single rubber belt unit. FIG. 12 shows the front view of a single rubber belt unit taken along the cutting plane C1-C1. FIG. 13 shows the top view of a single rubber belt unit taken along the cutting plane C1-C1. Cutting plane C2-C2 is taken at the edge where the dual tire rubber belt 004 bends around the tensioning tires 015 looking forward to the front. FIG. 14 shows the rear view of the dual tire rubber belt 004 taken along the cutting plane C2-C2.

The dual tire rubber belt 004 is constructed as continuous belt with repeated patterned units. The length of the unrepeated patterned unit is called a rubber belt unit. The backbone of the rubber belt 004 is a belt 024. The belt 024 includes an endless belt-shaped rubber-like elastic member, a canvas radially aligned high tension strength cords, and may include a number of core bars embedded therein and aligned laterally across the belt side to side. The radial canvas allows some shear motion within the rubber belt without buckling. The rubber belt tread 023, shown below the rubber belt 004 in FIG. 12, is attached outside the backbone of the rubber belt 004. The rubber belt tread 023 is made of abrasion resistance rubber suitable for road and off road usage with a raised tread pattern. The rubber belt tread 023 has a tread depth 061 as shown in FIG. 6. The raised pattern of the rubber belt tread 023 is chosen as a compromise of specific needs. Some of the many specific needs include a deep open self cleaning pattern for soft soils and a dense wear resistance pattern for high speed road usage. The rubber belt tread 023 protects the backbone of the rubber belt 004 from damage and grips the travel surface.

The dual track tires 003 run inside the dual tire rubber belt 004 along the rubber belt wheel runways 027. The rubber belt 004 is driven from the rear dual track tires 003 and perhaps also from the front dual track tires 003. The dual track tires 003 are prevented from spinning within the dual rubber belt 004 by static friction. The inside surface of the rubber belt 004 may have a shallow rib pattern to increase grip between the dual track tires 003 and the rubber belt 004. The shallow rib pattern is designed to reduce the dual track tires 003 from hydroplaning on the inner surface of the rubber belt 004. Rows of rubber belt guide horns 020, shown above the rubber belt 004 in FIG. 12, are attached inside the backbone of the rubber belt 004. Each track tire 003 runs along the rubber belt wheel runway 027 between two rows of rubber belt guide horns 020. In the center between the two rows of rubber belt guide horns 020 the rubber belt center runway 028 is unused. This rubber belt center runway 028 is not filled with rubber belt guide horns 020 because they are not needed and they would unnecessarily increase the rubber belt 004 weight. The track tires 003 are guided by the rubber belt guide horn inner edges 022. The guide horn inner edges 022 viewed from the end form a spline shape which allows the track tires 003 to pivot through a small angle without being pushed away from the rubber belt 004.

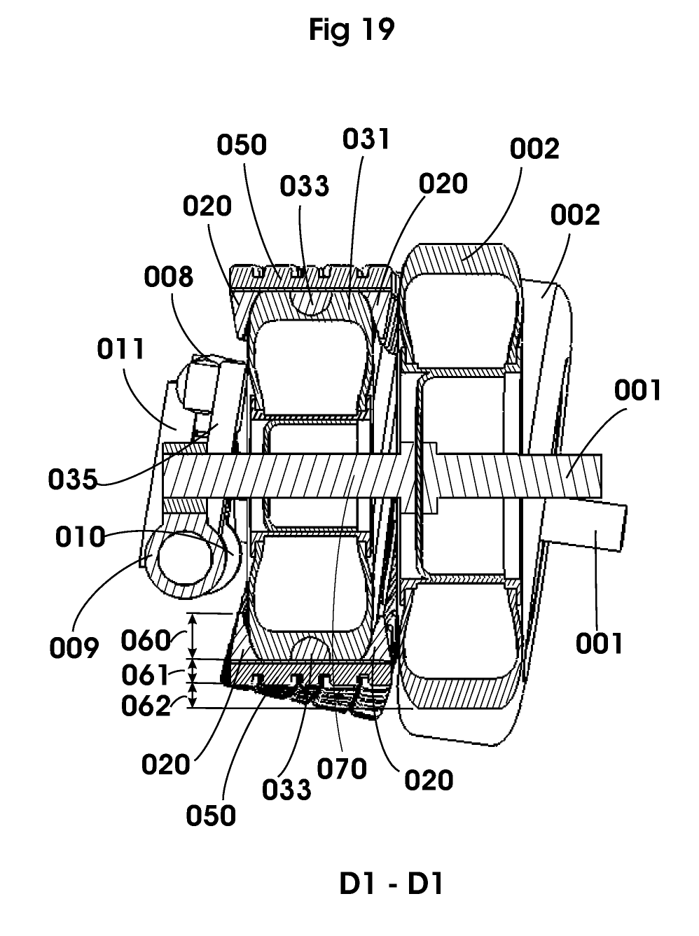

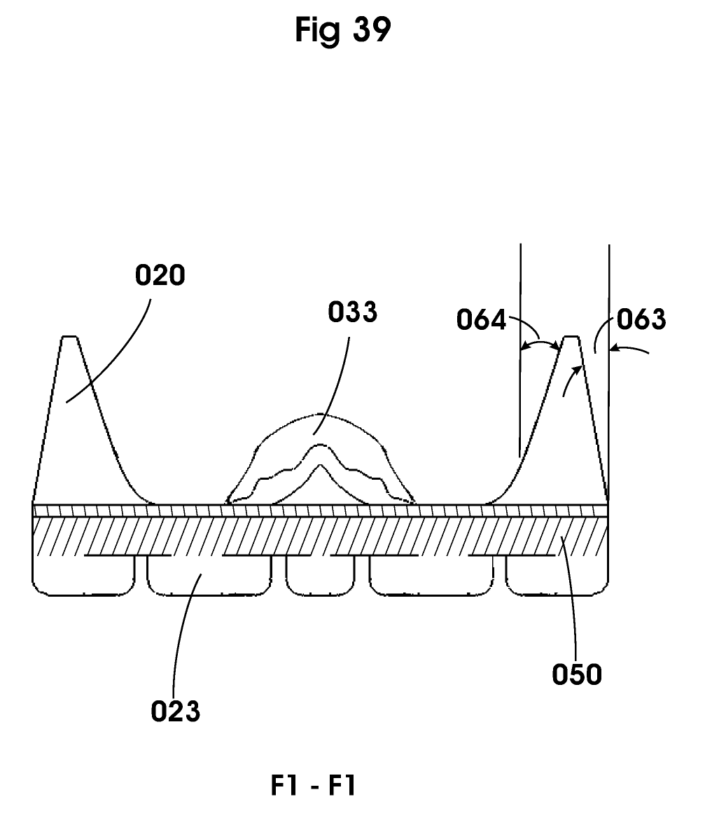

In FIG. 19, the angle of the track tires 031 pivot equals the axle shaft 001 pivot, which occurs as the vehicle travels over uneven terrain. Increasing the allowed track tire 031 pivot angle will increase the angle 064 of the guide horn inner edge 022 from vertical. The angle 064 is shown in FIG. 39. When large lateral forces are applied to the rubber belt 004, a large angle 064 of the guide horn inner edge 022 from vertical will cause the single track tires 031 to lifting off rubber belt 004 rather than laterally retaining them. As a result, only a few degrees of track tire 031 pivot are allowable.

The road tires 002 are located outside rubber belt 004 as shown in FIG. 5 and FIG. 8. When the road tires 002 are fully inflated, the tires side walls will not swell outwards significantly under the vehicle's weight. As a result when the road tires 002 are fully inflated there is a small gap 017 between the rubber belt guide horns 020 and the side walls of the road tires 002. The inflated road tires 002 also lifts the rubber belt 004 off the flat hard road surfaces creating a clearance 062 between the rubber belt 004 and the road surface. The small gap 017 between the rubber belt guide horns 020 and the side walls of the road tires 002 allows the rubber belt 004 to be disengaged traveling on flat hard road surfaces. When the road tires 002 are partially deflated, they will settle and lower the rubber belt 004 until it comes in contact with the ground surface. As the partially deflated road tires 002 settle under the vehicle weight, the bottom side walls of the road tires 002 will swell outwards eliminating the gap 017 between the road tires 002 and the rubber belt 004. The rubber belt guide horns outer edge 021 spreads the lateral load against the road tire 002 over a large side wall area. As shown in FIG. 12, the angle 064 of the guide horns inner edge 022 from vertical is designed to maximize the surface area in contact with road tires 002, provide lateral retention of the rubber belt 004, and direct the rubber belt 004 away from the road ties as the rubber belt 004 is pushed upwards towards the axle. In most situations a small angle 064 of the guide horns inner edge 022 from vertical, approximately 10 degrees is a good compromise.

The road tire 002 and the track tire 003 together form a V-belt pulley for the outer rubber belt guide horns 020. The larger diameter road tires 002 acts as a very deep pulley guide sidewall. When there is an excessive amount of debris between the dual track tires 003 and the rubber belt 004 or the rubber belt 004 is excessively twisted, the rubber belt guide horns 020 may slip off the dual track tires 003. Even in these extreme cases, the rubber belt 004 is prevented from being thrown by the larger diameter road tires 002. The larger diameter road tires form large flanges as shown in FIG. 5 and FIG. 8, which confines the rubber belt 004. Without the road tires 002 functioning as large flanges, the rubber belt 004 would be thrown when the rubber belt 004 is lifted away from the dual track tires 003. With road tires 002 functioning as large flanges, the rubber belt 004 needs to lift away from the track tires 003 by the guide horn height 060 plus the tread depth 061 plus the track road clearance 062. The road tires 002 also provide a greater surface area to resist rubber lateral forces of the rubber belt 004 on the dual track tires 003 by the amount of the tread depth 061. A further benefit of the road tires 002 located on both sides of the rubber belt 004 is that the rubber belt 004 will be guided between the road tires 002 as they push against the guide horns outer edges 021. As a result, the rubber belt 004 can have less tension than the equivalent ground pressure without a concern of the rubber belt 004 climbing off the dual track tires 003.

On soft soils or in loose debris, the road tires 002 sink down so that the rubber belt 004 comes in solid contact with the soft surface. As a result, the road tires 002 only sink into the soft surface by a small amount before the weight of the vehicle is supported by the high flotation rubber belt 004. Without the additional flotation provided by the rubber belt 004, the road tires 002 would sink beyond the point where they can climb out from the hole created by sinking. Also without the additional traction provided by the rubber belt 004, the road tires 002 would spin and dig deep holes in soft surfaces. The continuous rubber belt 004 can also bridge over loose debris such as boulders and fallen tree branches. The relatively smooth road tires 002 have a larger diameter than the rubber belt 004 and as a result the road tires 002 will push loose debris away from the guide horns 020. Debris should be kept away from the guide horns 020, which can grab debris in the guide horn gaps 030. The depressions the road tires 002 create on both sides of the rubber belt 004 act as gutters for the rubber belt 004 to dump debris.

The shock to both the road tires 002 and the dual track tires 003 from stones and pot holes can be extreme. In order to withstand the shock, the road tires 002 are assumed to be standard pneumatic tires, but they may be spring rubber. Similarly, the dual track tires 003 are assumed to be standard pneumatic or spring rubber tires. In either case, the road tires 002 and the dual track tires 003 are able to safely absorb shocks that might break a similar strength solid wheels.

The reduced footprint of only the road tires 002 on hard surfaces greatly reduces the turning force required to skid steer the hybrid rubber belt vehicle. The road tires 002 also push loose debris away from the rubber belt 004 as the vehicle turns. This is particularly important at the front and rear dual track tires 003. Debris entering the rubber belt 004 at the front or rear dual track tires 003 is pinched in between the guide horn gaps 030 as the rubber belt wraps around the dual track tires 003. By the road tires pushing loose debris away from the rubber belt 004, the danger of debris wedged between the guide horns 020 and lifting the rubber belt off the dual track tires 003 is avoided.

The top inside view of the rubber belt 004 is shown in FIG. 13 and FIG. 14. The front and back of each guide horn 020 forms an angled shape. In prior art designs, the front and back surfaces 025 and 026 of the rubber belt guide horns 020 may be perpendicular to the rubber belt 004 side. In this design, the front and back surfaces 025 and 026 of the guide horns 020 may be twisted in parallel as shown in FIG. 13 and FIG. 14. When the front and back surfaces 025 and 026 of the guide horns 020 are twisted in parallel, there is smaller straight through guide horn gap 030 in between the guide horns 020. The smaller straight through rubber belt guide horn gap 030 provides greater lateral support to the rubber belt 004 and makes it more difficult for debris to enter. Also if the rubber belt is forced to bend in a sharper angle than the wedge shape of the guide horns 020 was designed for, the twisted front and back surfaces of the guide horns 020 allow the rubber belt guide horns 020 to displace each other sideways rather than preventing the sharp bend angle. The guide horns 020 fit together end to end as shown in FIG. 14.

### Tensioning Idlers Construction

The dual tensioning tires 015 run inside the dual tire rubber belt 004 along the wheel runways 027. Each tensioning tire 015 runs along the wheel run way 027 between two rows of guide horns 020. The dual tensioning tires 015 are guided by the rubber belt guide horn inner edges 022. The guide horn inner edges 022 viewed from the end form a spline shape which allows the tensioning tires 015 to pivot through a small angle without being pushed away from the rubber belt 004. The pivot angle of the dual tensioning tires 015 is dependent on the twisting amount of the rubber belt 004. The tensioning pivot joint 036 prevents the rubber belt 004 from lifting off one side of the dual tensioning tires 015 as the rubber belt 004 twists. The twisting of the rubber belt 004 is caused by the difference in pivot angles between the front and rear axle shafts 001.

The tensioning track guides 006 are located outside rubber belt 004 as shown in FIG. 6 and FIG. 7. The outer guide horns 020 are held by the tensioning track guide 006 on the outside and the tensioning tire 015 on the inside. Together the tensioning track guide 006 and the tensioning tire 015 form a V-belt pulley for the outer guide horns 020. The amount of the tensioning track guides 006 extend beyond the rubber belt tread 023 is the rubber belt tensioning guide clearance depth 065. The guide horns outer edge 021 spreads the lateral load against the tensioning track guides 006 over a large area. The side wall slope of the tensioning track guides 006 is designed to maximize the surface area in contact with the guide horns outer edge 021. This provides lateral retention of the rubber belt 004, and centers the rubber belt 004 between the tensioning track guides 006 by the rubber belt 004 tension.

The continuous rubber belt 004 can also bridge over loose debris such as boulders and fallen tree branches. The smooth tensioning track guides 006 have a larger diameter than the rubber belt 004 surrounding the dual tensioning tires 015 and as a result they will push loose debris away from the guide horns 020. Debris should be kept away from the guide horns 020 because the guide horns can grab debris in the rubber belt guide horn gaps 030. The depressions the tensioning track guides 006 create on both sides of the rubber belt 004 act as gutters for the rubber belt 004 to dump debris.

The shock to both the tensioning track guides 006 and the dual tensioning tires 015 from stones can be extreme. To withstand shock from stones, the tensioning track guides 006 are assumed to be standard pneumatic or spring rubber tires. Similarly the dual tensioning tires 015 are assumed to be standard pneumatic or spring rubber tires. In either case the tensioning track guides 006 and the dual tensioning tires 015 are able to safely absorb shocks that might break a similar strength solid wheels.

The tensioning track guides 006 also push loose debris away from the rubber belt 004 as the vehicle turns. This is particularly important at the front and rear. Debris entering the rubber belt 004 at the front dual tensioning tires 015 is pinched in between the guide horn gaps 030 as the rubber belt 004 wraps around the dual tensioning tires 015. By the tensioning track guides 006 pushing loose debris away from the rubber belt 004, the danger of debris wedged between the guide horns 020 and lifting the rubber belt 004 off the dual tensioning tires 015 is avoided.

### Frame Operation

The suspension used by the hybrid rubber belt vehicle is not limited to track laying vehicle suspension. Track laying vehicle suspension has the advantage of not introducing axle shaft 001 vertical misalignment while traveling over rough terrine. Hybrid rubber belt vehicles with typical wheeled vehicle suspension such as solid axle, wishbone, McPherson strut and variations of these suspension types will sustain axle shaft 001 vertical misalignment while traveling over rough terrine. The hybrid rubber belt assembly is designed to accommodate a small amounts of axle shaft 001 vertical misalignment.

Typical wheeled vehicle suspension will cause the axle shafts 001 to tilt inwards as the road tires 002 and dual track tires 003 rise over bumps. Similarly the axle shafts 001 will tilt outwards as the road tires 002 and dual track tires 003 fall into depressions. The geometry of the suspension will cause the rubber belt 004 to twist. For the rubber belt 004 to accommodate twisting without buckling, the radial canvas embedded into the belt 024 allows an amount of lateral and longitudinal shear.

Separately raising the front axle shaft 001 or lowering the rear axle shaft 001 will cause top rear of the rubber belt 004 to twist outwards and the bottom rear of the rubber belt 004 to twist inwards. As the hybrid rubber belt vehicle travels forward, the rubber belt 004 needs to move inward along the top between the rear and front dual track tires 003 and moves outward along the bottom between the front and rear dual track tires 003. The outer edge of the rubber belt 004 also tightens as the front and rear axle shafts 001 move up and down separately. Some of the slackness along the inside edge of the rubber belt 004 will be taken up by the tensioning shaft 007 pivoting outwards on the tensioning pivot joint 036. The elastomer construction of the rubber belt's belt prevents the pivoting of the tensioning shaft 007 from taking up the inside edge slackness around the full length of the rubber belt 004. As a result the rubber belt 004 is forced to fit tightly around the outer dual track tire 003.

When each front dual track tire 003 applies inward lateral force against the guide horns inner edge 022 of each inside row of guide horns 020, the top of the rubber belt 004 is forced inwards. When the slightly looser inside edge of the rubber belt 004 rides up the inside front track tire 003, the rubber belt 004 will be held in place by its outer edge which is tightly fitted around the outer front track tire 003. The top of the rubber belt 004 is forced inwards by each dual tensioning tire 015 which applies inward lateral force against the guide horns inner edge 022 of each inside row of guide horns 020. The outside tensioning guide 006 applies lateral force against the guide horns outer edge 021 along the outside edge of the rubber belt 004. Furthermore the rubber belt 004 is prevented from slipping outwards and off from the front dual track tires 003 by the outside front road tire 002 which applies lateral force against the guide horns outer edge 021 along the outside edge of the rubber belt 004.

The bottom of the rubber belt 004 is forced inwards by each rear dual track tire 003 applying inward lateral force against the rubber belt guide horns inner edge 022 of each inside row of rubber belt guide horns 020. When the slightly looser inside edge of the rubber belt rides down the inside rear track tire 003, the rubber belt 004 will be held in place by its outer edge which is tightly fitted around the outer rear track tire 003. Furthermore the rubber belt 004 is prevented from slipping outwards and off from the dual track tires 003 by the outside rear road tire 002 which applies lateral force against the rubber belt guide horns outer edge 021 of the row of rubber belt guide horns 020 along the outside edge of the rubber belt 004.

Separately lowering the front axle shaft 001 or raising the rear axle shaft 001 will cause top rear of the rubber belt 004 to twist inwards and the bottom rear of the rubber belt 004 to twist outwards. As the hybrid rubber belt vehicle travels forward, the rubber belt 004 needs to move outward along the top between the rear and front dual track tires 003 and needs to move inward along the bottom between the front and rear dual track tires 003. The outer edge of the rubber belt 004 also tightens as the front and rear axle shafts 001 move up and down separately. Some of the slackness along the inside edge of the rubber belt 004 will be taken up by the tensioning shaft 007 pivoting outwards on the tensioning pivot joint 036. The elastomer construction of the rubber belt's belt prevents the pivoting of the tensioning shaft 007 from taking up the inside edge slackness around the full length of the rubber belt 004. As a result the rubber belt 004 is forced to fit tightly around the outer track tire 003.

When each front dual track tire 003 applies outwards lateral force against the guide horns inner edge 022 of each outside row of guide horns 020, the top of the rubber belt 004 is forced outwards. When the slightly looser inside edge of the rubber belt 004 rides up the inside front track tire 003, the rubber belt 004 is held in place by its outer edge which is tightly fitted around the outer front track tire 003. The top of the rubber belt 004 is forced outwards by each dual tensioning tire 015 which applies outward lateral force against the guide horns inner edges 022 of each inside row of guide horns 020. The inside tensioning guide 006 applies lateral force against the track guide horns outer edge 021 of the row of guide horns 020 along the inside edge of the rubber belt 004. Furthermore the rubber belt 004 is prevented from slipping inwards and off the front dual track tires 003 by the inside front road tire 002 which applies lateral force against the guide horns outer edge 021 along the inside edge of the rubber belt 004.

The bottom of the rubber belt 004 is forced outwards by each rear dual track tire 003 applying inward lateral force against the guide horns inner edge 022 of each outside row of guide horns 020. When the slightly looser inside edge of the rubber belt 004 rides down the inside rear track tire 003, the rubber belt 004 is held in place by its outer edge which is tightly fitted around the outer rear track tire 003. Furthermore the rubber belt 004 is prevented from slipping inwards and off the rear dual track tires 003 by the inside rear road tire 002 which applies lateral force against the rubber belt guide horns outer edge 021 along the inside edge of the rubber belt 004.

In an outward rear skid turn, the rubber belt 004 is forced inwards on the rear and forced outwards on the front. The outside rear road tire 002 clears debris away from rear dual track tires 003. The inside rear road tire 002 provides extra protection preventing the rubber belt 004 from slipping off the rear dual track tires 003 and sliding inwards. The inside front road tire 002 clears debris away from the front dual track tires 003. The outside front road tire 002 provides extra protection preventing the rubber belt 004 from slipping off the front dual track tires 003 and sliding outwards.

Similarly in an inward rear skid turn, the rubber belt 004 is forced outwards on the rear and forced inwards on the front. The inside rear road tire 002 clears debris away from rear dual track tires 003. The outside rear road tire 002 provides extra protection preventing the rubber belt 004 from slipping off the rear dual track tires 003 and sliding outwards. The outside front road tire 002 clears debris away from the front dual track tires 003. The inside front road tire 002 provides extra protection preventing the rubber belt 004 from slipping off the front dual track tires 003 and sliding inwards.

Near constant tensioning is maintained in the rubber belt 004 by the hydro-pneumatic cylinder 008 which applies a nearly constant extension force. The hydro-pneumatic cylinder 008 applies longitudinally outward force to the tensioning shaft 007. The constant force applied by the dual tensioning tires 015 maintains a constant rubber belt 004 tension. The rubber belt 004 length is shortened by twisting. A longer rubber belt 004 length is required when the rubber belt 004 is supporting the vehicle's weight on boulders, tree limbs or other hard debris. As the vehicle craws over the hard debris, the vehicle's weight forces the rubber belt 004 upwards. When the rubber belt 004 is not directly supported by the dual track tires 003, the rubber belt 004 is allowed to bend upwards. This upwards bending of the rubber belt 004 results in a longer rubber belt 004 length required when the vehicle craws over hard debris. When sticky debris accumulates around the dual track tires 003 or in the rubber belt wheel runway 027, the effective track tire 003 size increases. Changing track tire 003 size also requires rubber belt 004 length to change. The hydro-pneumatic cylinder 008 dynamically extends and retracts to accommodate changes in the required length of the rubber belt 004.

Optionally the rubber belt 004 may be disengaged during on road usage to reduce rubber belt 004 wear, heat and noise. Disengaging the rubber belt 004 during high speed travel greatly reduces any chance of throwing a high velocity rubber belt with a destructive amount of kinetic energy. In order to be able to disengage the rubber belt, the dual track wheel rims 014 are bolted to a brake assembly which is in turn bolted onto the rear axle shaft extension 070. Also the road tires 002 need to be inflated such that there is a clearance between the rubber belt 004 and the road surface. The rubber belt 004 is disengaged from the road tires 002 by releasing the brakes of the brake assembly to which dual track wheel rims 014 are bolted. With the rubber belt 004 disengaged, the rubber belt 004 is able to freely rotate or cease to rotate as the hybrid rubber belt vehicle travels on roads. The rubber belt 004 is re-engaged with the road tires 002 by applying the brakes of the brake assembly to which dual track wheel rims 014 are bolted.

To change either the front or rear outside road tire 002, the vehicle is lifted on jacks so that the outside road tire 002 to be removed is no longer bearing the vehicle's weight. The outside road wheel rim 013 together with the mounted road tire 002 are unbolted from axle extension 070. After the outside road tire 002 and outside road wheel rim 013 have been removed, the road tire 002 is taken off and a replacement road tire 002 is put on the road wheel rim 013. The outside road tire 002 and outside road wheel rim 013 are bolted onto the axle extension 070. Finally the vehicle is lowered and jacks are removed.

To change the rubber belt 004 without breaking the endless belt, the vehicle is jacked so that neither the outside road tires 002 nor the rubber belt is bearing the vehicle's weight. Both front and rear outside road wheel rims 013 together with the mounted road tires are unbolted from the axle extensions 070. After the outside road tires 002 with road wheel rims 013 have been removed the hydro-pneumatic cylinder 008 is retracted. With the hydro-pneumatic cylinder 008 retracted, the rubber belt 004 can be slipped over the dual tensioning tires 015 and idle guides 006. The rubber belt 004 is also slipped over the dual track tires 003 and removed. A replacement rubber belt 004 is similarly put on by slipping it over the dual track tires 003, the dual tensioning tires 015 and idle guides 006. The outside road tires 002 and outside road wheel rims 013 are bolted onto the axle extensions 070. Finally the vehicle is lowered and jacks are removed.

To change either the front or rear inside road tire 002 or remove the track assembly, the vehicle is jacked so that neither the road tires 002 nor the rubber belt 004 is bearing the vehicle's weight. If there is sufficient clearance in the gap 017 between road tire 002 and rubber belt 004, a suitable wrench can be inserted. The front and rear axle extensions 070 can be unbolted with a suitable wrench. The front and rear axles 001 and the complete assembly attached to the axle extensions 070 can be removed in one step. The complete assembly attached to the axle extensions 070 consists of the track frame, tensioning idlers, track tires 003, outer road ties 002 and rubber belt 004. Otherwise, the rubber belt 004 is removed as described previously. After the rubber belt 004 has been removed, the gap between the inside track tire 003 and the inside road tire 002 will be more than sufficient to insert a suitable wrench. If there are no means of lifting the complete assembly attached to the axle extensions 070, the assembly can be first disassembled. With a means of lifting, the complete assembly is attached to the axle extensions 070. The front and rear axle extensions 070 can be unbolted from the front and rear axles 001 and the complete assembly attached to the axle extensions 070 can be removed. Otherwise the assembly needs to be disassembled and removed one piece at a time until the complete assembly attached to the axle extensions 070 has been removed.

To disassemble the complete assembly attached to the axle extensions 070, the rubber belt 004 is removed as described previously. The hydro-pneumatic cylinder 008 can be disconnected at the front 041 and rear 040 hinge joints which allows the hydro-pneumatic cylinder 008 to be removed. The front track frame 071 is unbolted from the rear track frame 005 and the attached tensioning idler assembly is removed. The rear track frame 005 is disconnected from the rear axle extension 070 by separating the track frame pivot joint 009 from the rear axle joint 018. The rear track frame 005 is slid forward in the track frame slide joint 010 until the rear track frame 005 clears the rear dual track tires 003. The rear axle extension 070 is unbolted from the rear axle 001 allowing the rear axle extension 070 and the attached dual rear track tires 003 to be removed. The rear track frame 005 is slid backwards and out of the track frame slide joint 010. The front axle extension 070 is unbolted from the front axle 001 and rear axle extension 070 and the attached dual front track tires 003 are removed.

At this point the track assembly has been completely removed leaving only the inside road tires 002 and road wheel rims 013 bolted onto the axle shafts 001. At this point either front or rear inside road tire can be replaced or the track assembly may be left removed reducing the total vehicle width. To replace either the front or rear inside road tire 002, the inside road wheel rim 013 together with the mounted road tire are unbolted from the axle 001. After the inside road tire 002 and inside road wheel rim 013 have been removed, the road tire 002 is taken off and a replacement road tire 002 is put on the road wheel rim 013. The inside road tire 002 and outside road wheel rim 013 are bolted onto the axle 001. Process of reattaching the track assembly is performed by reversal of the removal steps.

### CONCLUSION, RAMIFICATIONS, AND SCOPE

Although the invention has been described and demonstrated with reference to specific preferred embodiments, it should be understood by those who are skilled in the art that some modification in form and detail may be made therein without deviating from the spirit and scope of the invention as defined in the following claims.

Many other variations are possible. For example these variations include track laying systems where the drive wheels do not support the vehicle's weight as it travels over terrain. Other variations include implementations where the tensioning wheels also support the vehicle's weight as it travels over terrain.

The first variation embodiment where drive wheels do not support the vehicle's weight is quite popular and is used by a wide variety of vehicles including most military track laying vehicles. In this embodiment track and road wheels support the vehicle weight as it travels over terrain. Track wheel axles are connected to a frame or vehicle body by suspension elements. These suspension elements insure the track wheel axles remain parallel or nearly so through the suspension travel, with each other, with the drive wheel axle and with the tensioning axle. Each track wheel axle has one or more track wheels attached. Prior art track laying systems do not include road wheels which are mounted beside and in proximity to the track. This invention further includes larger diameter road wheels attached on the track wheel axles on either one side or both sides of the track. These road wheels are a greater radius than the combined radius of track wheels and the track thickness. These road wheels are located in close proximity beside the track and support the vehicle's weight on hard ground and roads, such that the track is unloaded or lightly loaded.

The advantages provided by the road wheels included in this invention are increased protection from debris entering the track during turning, reduced track wear and heat generation hard ground and roads, bearing greater side loading forces without requiring large track guide wedges, reduced force required to turn, this is particularly true when turning on hard surfaces, the track confined between guides and road wheels greatly reduces the possibility of de-tracking of band tracks, reduced track angular momentum and kinetic energy when the vehicle is traveling at high speeds on roads and the track rotation is decoupled from road wheel rotation.

Thus the scope of the invention should be determined not by the embodiments illustrated, but by the appended claims and their legal equivalents.

What is claimed is:

1. A means of track laying for a vehicle, comprising:
a. an inextensible track having one or more longitudinal rows of guide wedges located on the interior surface of said track,
b. a plurality of track wheels that run on said lower interior surface of said track, such that said track wheels support a portion of or all of said vehicle's weight, such that said track wheels fit snugly against one or more said longitudinal rows of said guide wedges, such that one or more of said track wheels may simultaneously serve as drive wheels, and such that one or more of said track wheels may simultaneously serve as tensioning wheels,
c. a plurality of track wheel axles, such that one or more of said track wheels is mounted to each said track wheel axle, such that one or more of said track wheel axles may simultaneously serve as drive axles, and such that one or more of said track wheel axles may simultaneously serve as tensioning axles,
d. one or more drive axles, such that each said drive axle is connected to said vehicle and such that each said drive axle is forcibly rotated by one or more apparatuses associated with said vehicle and/or restrained by one or more apparatuses associated with said vehicle,
e. a plurality of road wheels, such that said road wheels are mounted on said track wheel axles, such that said road wheels are adjacent to said track, such that said road wheels have a greater radius than the combined radius of said track wheels and thickness of said track, such that on a hard even travel surface said road wheels fully or primarily support said vehicle's weight, such that said road wheels function as guides preventing said track from moving sufficiently sideways to slide off said track wheels that run on said lower interior surface of said track, such that one or more of said road wheels may simultaneously serve as drive guide wheels, and such that one or more of said road wheels may simultaneously serve as tensioning guide wheels,
f. a transaction enhancing material fixed to the outside circumference of said road wheels,
g. one or more track wheel axle supporting structures for supporting said vehicle's weight, such that each said track wheel axle supporting structure is attached to said vehicle and one or more said track wheel axles, and such that said vehicle weight is carried through one or more said track wheel axle supporting structures and applied to said track wheel axles,
h. one or more means of maintaining proper tension of said track with the first part of said means of maintaining proper tension fixed in reference to said track wheel axle supporting structure, and such that the second part of said means of maintaining proper tension moves with respect to said first part,
i. one or more said tensioning axles, such that each said tensioning axle is connected to said second part of a said means of maintaining proper tension,
j. one or more tensioning wheels that run on said interior surface of said track, such that said tensioning wheels are mounted on one or more said tensioning axles, such that said tensioning wheels apply tensioning force to said track, such that said tensioning wheels fit snugly against one or more said longitudinal rows of said guide wedges, and such that said tensioning axle is attached to said second part of said means of maintaining proper tension,
k. one or more tensioning guide wheels mounted on one or more said tensioning axles, such that one of said tensioning guide wheels is located on one side of said track, such that if there is more than one said tensioning guide wheel, one of said tensioning guide wheels is located on the other side of said track, such that said tensioning guide wheels prevent said track from moving sufficiently sideways to slide off said tension wheels that run on said interior surface of said track,
l. one or more drive wheels that run on said interior surface of said track, such that said drive wheels are mounted on one or more said drive axles, such that said drive wheels apply drive torque to said track, and such that said drive wheels fit snugly against one or more said longitudinal rows of said guide wedges,
m. one or more drive guide wheels mounted on one or more said drive axles, such that one of said drive guide wheels is located on one side of said track, such that if there is more than one said drive guide wheel, one of said drive guide wheels is located on the other side of said track, and such that said drive guide wheels prevent said track from moving sufficiently sideways to slide off said drive wheels that run on said interior surface of said track,
whereby said road wheels, said tensioning guide wheels, and said drive guide wheels protect the edge of said track by pushing debris away from said track,
whereby said road wheels, said tensioning guide wheels, and said drive guide wheels inhibit said track from moving sufficiently sideways to slide off said track wheels, said tensioning wheels, and/or said drive wheels,
whereby the amount of side loading force that said track is able to bear before sliding sideways off said track wheels, said tensioning wheels, and/or said drive wheels is greatly increased by said road wheels, said tensioning guide wheels, and said drive guide wheels,
whereby said road wheels, said tensioning guide wheels, and said drive guide wheels lift said track off even and hard travel surfaces reducing wear and extending useful life of said track.

2. The means of track laying as set forth in claim 1, further including:
a. said longitudinal rows of guide wedges located along the outer edge or edges of said track,
b. said tensioning guide wheels have a greater diameter than said track fitted around said tensioning wheels, such that said longitudinal rows of said guide wedges are confined between said tensioning guide wheels and said tensioning wheels,
whereby sideways movement of said track is reduced by said confined longitudinal rows of said guide wedges,
whereby reduced sideways movement of said track improves alignment and reduces uneven wear of said track,
whereby reduced sideways movement of said track increases the amount of side loading force said track is able to bear before sliding sideways off said track wheels, said tensioning wheels, and/or said drive wheels.

3. The means of track laying as set forth in claim 1, further including:
a. said longitudinal rows of guide wedges located along the outer edge or edges of said track,
b. said drive guide wheels have a greater diameter than said track fitted around said drive wheels, such that said longitudinal rows of said guide wedges are confined between said drive guide wheels and said drive wheels, such that contacting surface is between said confined longitudinal rows of said guide wedges and said drive wheels and/or such that contacting surface is between said confined longitudinal rows of said guide wedges and said drive wheel guides and such that said contacting surface provides a large surface friction,
whereby said large surface friction enables a large torque to be transmitted through said drive axles to said track,
whereby sideways movement of said track is reduced by said confined longitudinal rows of said guide wedges,
whereby reduced sideways movement of said track improves alignment and reduces uneven wear of said track,
whereby reduced sideways movement of said track increases the amount of side loading force said track is able to bear before sliding sideways off said track wheels, said tensioning wheels, and/or said drive wheels.

4. The means of track laying as set forth in claim 1, further including a frame to which said drive axles, said track wheel axle supporting structures, and/or said first part of said means of maintaining proper tension are attached, such that said frame bears forces between said drive axles, said track wheel axle supporting structures, and/or said first part of said means of maintaining proper tension and such that said frame may also be directly attached to said vehicle,
whereby said frame is an efficient means of transmitting force between said drive axles, said track wheel axle supporting structures, and/or said first part of said means of maintaining proper tension,
whereby said frame reduces forces on said vehicle attachment points of said drive axles, said track wheel axle supporting structures, and/or said first part of said means of maintaining proper tension.

5. The means of track laying as set forth in claim 1, further including one or more track wheel axle suspension, such that each said track wheel axle has a track wheel axle suspension and such that each said track wheel axle suspension absorbs impacts by said track wheels and said road wheels with surface terrain upon which said vehicle moves,
whereby the life expectancy of said vehicle and said means of track laying is increased by said track wheel axle suspension absorbing impacts by said track wheels and said road wheels with surface terrain upon which said vehicle moves.

6. The means of track laying as set forth in claim 1, further including tires that absorb impacts mounted on the circumference of said road wheels and/or said track wheels and such that said tires absorb impacts by said track wheels and said road wheels with surface terrain upon which said vehicle moves,
whereby the life expectancy of said vehicle and said means of track laying is increased by said tires absorbing impacts.

7. The means of track laying as set forth in claim 1, further including a fixed mounted or spring mounted means of removing debris between any or all sets of said track wheels and said road wheels, said tensioning wheels and said tensioning guide wheels, and/or said drive wheels and said drive guide wheels,
whereby accumulation of debris is prevented between any or all said sets of said track wheels and said road wheels, said tensioning wheels and said tensioning guide wheels, and/or said drive wheels and said drive guide wheels,
whereby said track is prevented from coming off due to said accumulation of debris between any or all said sets of said track wheels and said road wheels, said tensioning wheels and said tensioning guide wheels, and/or said drive wheels and said drive guide wheels.

8. The means of track laying as set forth in claim 1, further including one or more longitudinal rows of uniformly spaced drive lugs located on the interior surface of said track, such that said drive wheels mesh with said drive lugs,
whereby friction between said drive wheels and said track is increased by the meshing of said drive wheels with one or more said longitudinal rows of uniformly spaced drive lugs.

9. The means of track laying as set forth in claim 1, further including a means of adjusting the ride height of said road wheels, such that increasing the ride height of said road wheels lifts said track further off said travel surface and such that decreasing the ride height of said road wheels lowers said track further toward said travel surface,
whereby the portion of said vehicle weight supported by said road wheels and said track wheels is adjusted by said means of adjusting the ride height of said road wheels.

10. The means of track laying as set forth in claim 1, further including:
a. either said track wheels decoupled from said road wheels or a means of decoupling said track wheels from said road wheels, such that when said track wheels are decoupled from said road wheels, then they rotate independently,
b. either said drive wheels decoupled from said drive wheel axles or a means of decoupling said drive wheels from said drive wheel axles, such that when said drive wheels are decoupled from said drive wheel axles, then said drive wheels and said drive wheel axles rotate independently, and such that when said drive wheels are coupled to said drive wheel axles, then said drive wheels and said drive wheel axles rotate in unison,
c. either said track decoupled from said road wheels or a means of decoupling said track from said road wheels, such that when said track is decoupled from said road wheels and said track wheels are decoupled from said road wheels and when said drive wheels are decoupled from said drive wheel axles, then said track rotates independently of said road wheels,
whereby when said drive wheels are coupled to said drive wheel axles, then said track rotates in unison with said drive wheel axles,
whereby when said drive wheels are coupled to said drive wheel axles, then said vehicle is propelled by said road wheels and said track,
whereby when said drive wheels are decoupled from said drive wheel axles, then said track rotates independently of said drive wheel axles,
whereby said track rotation speed can be less than that of said vehicle speed over said travel surface,
whereby when said drive wheels are decoupled from said drive wheel axles, then said vehicle is propelled by only said road wheels,
whereby the angular momentum and kinetic energy of said track is reduced during high speed operation of said vehicle by decoupling said drive wheels from said drive wheel axles and allowing said track to rotate independently.

11. The means of track laying as set forth in claim 1, further including:
a. a plurality of self-aligning curvilinear track teeth, such that the longitudinal cross section of each said self-aligning curvilinear track tooth is that of a curvilinear synchronous timing track tooth that is not self-aligning, such that the latitudinal cross section of each said self-aligning curvilinear track tooth is sloped outward toward the base of each said curvilinear track tooth, such that said latitudinal cross section of each said self-aligning curvilinear track tooth is rounded at the upper and lower portions, and such that latitudinal cross section of each said self-aligning curvilinear track tooth is devoid of abrupt corners,
b. an inextensible track having one or more longitudinal rows of spaced plurality of said self-aligning curvilinear track teeth located on the interior surface of said track, such that said drive wheels mesh with said curvilinear track teeth, whereby torque is smoothly transmitted between said self-aligning synchronous track teeth and meshing of said drive wheels,
whereby said self-aligning curvilinear synchronous track teeth are self-aligning.

12. A self-aligning synchronous belt, comprising:
a. a plurality of self-aligning curvilinear belt teeth, such that the longitudinal cross section of each said self-aligning curvilinear belt tooth is that of a curvilinear synchronous timing belt tooth that is not self-aligning, such that the latitudinal cross section of each said self-aligning curvilinear belt tooth is sloped outward toward the base of each said curvilinear belt tooth, such that said latitudinal cross section of each said self-aligning curvilinear belt tooth is rounded at the upper and lower portions, and such that latitudinal cross section of each said self-aligning curvilinear belt tooth is devoid of abrupt corners,
b. an inextensible belt having one or more longitudinal rows of spaced plurality of said self-aligning curvilinear belt teeth located on the interior surface of said belt,
whereby torque is smoothly transmitted between said self-aligning synchronous belt and meshing pulley,
whereby said self-aligning curvilinear synchronous belt teeth provided power transmission efficiency comparable to curvilinear synchronous timing belt teeth that are not self-aligning,
whereby said self-aligning curvilinear synchronous belt teeth are self-aligning.
